(19) United States
(12) Patent Application Publication
(10) Pub. No.: US 2019/0177559 A1
(43) Pub. Date: Jun. 13, 2019

(54) SOLVENT-BASED GRAVURE PRINTING INK FOR LAMINATION, PRINTED MATERIAL AND LAMINATE

(71) Applicants: TOYO INK SC HOLDINGS CO., LTD., Tokyo (JP); TOYO INK CO., LTD., Tokyo (JP)

(72) Inventors: Harunori NARIHIRO, Tokyo (JP); Hideki YASUDA, Tokyo (JP); Youichi HASHIMOTO, Tokyo (JP); Takashi OKAMURA, Tokyo (JP); Michihiro NODA, Tokyo (JP); Michihisa KOFUJI, Tokyo (JP)

(73) Assignees: TOYO INK SC HOLDINGS CO., LTD., Tokyo (JP); TOYO INK CO., LTD., Tokyo (JP)

(21) Appl. No.: 16/309,240

(22) PCT Filed: Jul. 12, 2017
(86) PCT No.: PCT/JP2017/025459

§ 371 Date: Dec. 12, 2018

(30) Foreign Application Priority Data
Jul. 27, 2016 (JP) 2016-147360
Feb. 9, 2017 (JP) 2017-021944

(51) Int. Cl. C09D 11/033; B32B 7/12; C09D 11/102; C09D 11/106

(52) U.S. Cl. CPC C09D 11/033; C09D 11/106; C09D 11/102; B32B 7/12

(57) ABSTRACT

A solvent-type gravure ink for a laminate according to the present invention contains a pigment, a binder resin, an organic solvent, and water. The solvent-type gravure ink contains 80 to 100 mass % in total of a polyurethane resin and a vinyl chloride copolymer resin in 100 mass % of the binder resin, and the mass ratio of polyurethane resin to vinyl chloride copolymer resin is 95:5 to 40:60. The solvent-type gravure ink contains 1 to 50 mass % of a structural unit derived from a polyether in 100 mass % of the polyurethane resin. The solvent-type gravure ink contains 0.1 to 15 mass % of a glycol ether-based organic solvent serving as the organic solvent and 0.1 to 5 mass % of the water in 100 mass % of the gravure ink.

### TECHNICAL FIELD

The present invention relates to a solvent-type gravure ink for laminate, a printed material, and a layered product.

### BACKGROUND ART

When a film substrate, such as an OPP film, a PET film, or an NY film, is used as a packaging material or the like, printing is typically performed thereon with the use of printing ink for decorating the substrate or protecting the surface of the substrate. The printed substrate is subjected to a slit process and a lamination process, as necessary, and results in a package for various applications, including food packaging and cosmetic packaging, in the end.

Examples of methods of printing on the film substrate or a paper substrate include a gravure printing method. A plate used in the gravure printing method includes recess portions (cells) corresponding to portions for printing letters, patterns, and so on. Ink (gravure ink) is made to adhere to the plate to such an extent that allows the ink to be held in the recess portions (cells), excess ink on the surface is scraped off by a doctor blade while the plate is being rotated, and the ink is transferred and applied to the substrate. This printing method allows for expressing fine shades and is thus suitable for reproducing rich gradations in a photograph or the like. In addition, this printing method allows for high-speed printing and is thus suitable for mass production.

In the lamination process, a film is affixed onto a substrate printed with ink with the use of an adhesive. Methods therefor are roughly classified into three systems: an extrusion lamination system, a dry lamination system, and a non-solvent lamination system.

### CITATION LIST

### Patent Literature

Patent Literature 1: Japanese Unexamined Patent Application Publication No. H9-328646

Patent Literature 2: Japanese Unexamined Patent Application Publication No. 2014-005318

Patent Literature 3: Japanese Unexamined Patent Application Publication No. 2010-270216

Patent Literature 4: Japanese Unexamined Patent Application Publication No. 2005-298618

Patent Literature 5: Japanese Unexamined Patent Application Publication No. 2013-213109

### SUMMARY OF INVENTION

### Technical Problem

Problems that the gravure printing method faces in terms of printability include (I) whitening of a printed coat of ink, (II) wear of a doctor blade due to ink deposits, and (III) filming of a coat of ink produced in an ink pan under a high-temperature, high-humidity environment in summer. When these problems arise, printing becomes impossible, which may delay the operation. Even if printing can be carried out, a transfer defect onto a substrate, an occurrence of streaks, a decrease in the handleability of ink, a decrease in the productivity, and so on may arise. A defective print product is treated as a defective lot in a print converter and results in a production loss. These issues are prominent in a non-toluene solvent-based gravure ink, which is currently in the mainstream. This is conceivably because the solvency of the solvent is lower in a non-toluene solvent-based gravure ink than in a toluene solvent-based gravure ink that has been in the mainstream conventionally.

To date, various attempts have been made to improve the printability. For example, to make an improvement against the plate clogging, a solvent-based gravure ink that contains glycol ether or water has been proposed (Patent Literature 1). In addition, to improve the ink stability and the two-component stability, a gravure ink (liquid ink) in which a vinyl chloride/vinyl acetate copolymer and styrene-maleic anhydride are blended has been proposed (Patent Literature 2). However, a technique that ensures the printability under a high-temperature, high-humidity environment has not yet been established. In addition, although it is conceivable to improve the printability by changing the design of a binder resin to be used, a suitable design has not yet been established.

The presence of a defective portion on a printed material leads to an increased possibility that a defect occurs in the lamination process in postprocessing. What is feared in the lamination process includes an appearance detect, insufficient lamination strength, and insufficient boiling resistance and retort resistance. To reduce such defects, various measures have been taken (Patent Literatures 3 to 5). However, to date, there has been none that satisfies both the printability and the lamination performance. Depending on the pigment type, it is difficult to improve the printability due to insufficient ink stability or the like.

The present invention is directed to providing a solvent-type gravure ink for a laminate that experiences no whitening of a printed layer, produces less filming and doctor wear associated with ink deposits, and excels in printability in gravure printing under a high-temperature, high-humidity condition.

### Solution to Problem

The present inventors have conducted diligent research on the problem described above and found that the problem can be solved by using a printing ink composition for a laminate described hereinafter, and thus the present invention has been completed.

A solvent-type gravure ink for a laminate according to the present invention contains a pigment (A), a binder resin (B), an organic solvent (C), and water (D) and satisfies the following (1), (2), and (3).

(1) The solvent-type gravure ink contains 80 to 100 mass % in total of a polyurethane resin (b1) and a vinyl chloride copolymer resin (b2) in 100 mass % of the binder resin (B), and the mass ratio of (b1) and (b2) is (b1):(b2)=95:5 to 40:60.

(2) The solvent-type gravure ink contains 1 to 50 mass % of a structural unit derived from a polyether in 100 mass % of the polyurethane resin (b1).

(3) The solvent-type gravure ink contains 0.1 to 15 mass % of a glycol ether-based organic solvent (c1) serving as the organic solvent (C) and 0.1 to 5 mass % of the water (D) in 100 mass % of the gravure ink.

In the solvent-type gravure ink for a laminate according to the present invention, it is preferable that the glycol ether-based organic solvent (c1) have a solubility parameter of 9.0 to 12.0.

In addition, it is preferable that the glycol ether-based organic solvent (c1) have a boiling point of 110° C. to 240° C.

In one aspect, the pigment (A) can include an organic pigment and can include, for example, at least one organic pigment selected from the group consisting of a phthalocyanine pigment and an azo lake pigment.

In another aspect, the pigment (A) can include a titanium oxide pigment. It is preferable that the titanium oxide pigment be at least a rutile-type titanium oxide surface-treated with at least one metal oxide selected from the group consisting of silica and alumina.

In the solvent-type gravure ink for a laminate according to the present invention, it is preferable that the glycol ether-based organic solvent (c1) be at least one selected from the group consisting of ethylene glycol monoalkyl ether and propylene glycol monoalkyl ether.

A printed material according to the present invention has a printed layer on a substrate, the printed layer being printed with the above-described solvent-type gravure ink for a laminate.

A layered product according to the present invention includes at least an adhesive layer and a film layer provided in this order on the printed layer of the above-described printed material.

### Advantageous Effects of Invention

According to the present invention, it is possible to provide a solvent-type gravure ink for a laminate that experiences no whitening of a printed layer, produces less filming and doctor wear associated with ink deposits, and excels in printability in gravure printing under a high-temperature, high-humidity condition.

### DESCRIPTION OF EMBODIMENTS

Hereinafter, embodiments of the present invention will be described in detail. The descriptions of the constituent elements below, however, illustrate examples (representative examples) of the embodiments of the present invention, and the present invention is not limited to the following content unless departing from the spirit thereof.

A solvent-type gravure ink for a laminate according to the present invention contains a pigment (A), a binder resin (B), an organic solvent (C), and water (D) and satisfies the following (1), (2), and (3).

(1) The solvent-type gravure ink contains 80 to 100 mass % in total of a polyurethane resin (b1) and a vinyl chloride copolymer resin (b2) in 100 mass % of the binder resin (B), and the mass ratio of (b1) and (b2) is (b1):(b2)=95:5 to 40:60.

(2) The solvent-type gravure ink contains 1 to 50 mass % of a structural unit derived from a polyether in 100 mass % of the polyurethane resin (b1).

(3) The solvent-type gravure ink contains 0.1 to 15 mass % of a glycol ether-based organic solvent (c1) serving as the organic solvent (C) and 0.1 to 5 mass % of the water (D) in 100 mass % of the gravure ink.

In printing under a high-temperature, high-humidity condition, the solubility of a pigment dispersion (solid content in ink) in ink decreases, and thus the solid component tends to deposit easily. According to the present invention, when the polyurethane resin (b1) contains 1 to 50 mass % of a structural unit derived from a polyether, the solubility of the pigment dispersion in an organic solvent improves, and thus an effect of suppressing deposits is obtained. In addition, the use of the vinyl chloride copolymer resin (b2) (preferably, a vinyl chloride copolymer resin (b2) having a hydroxyl group) improves the dispersiveness of the pigment to yield a stable dispersion, and thus the solubility of ink improves. Meanwhile, the solvent-type gravure ink for a laminate according to the present invention includes the organic solvent (C). As the organic solvent (C), although a non-aromatic organic solvent (so-called non-toluene-based solvent) is preferable as it is highly safe and improves the color saturation of halftone dots, the power of dissolving resin or a pigment dispersion, which is a solid content in ink, of the non-aromatic organic solvent tends to be lower than that of an aromatic organic solvent (so-called toluene-based solvent), such as toluene or xylene. However, as the ink includes 0.1 to 15 mass % of the glycol ether-based organic solvent (c1) as the organic solvent (C) and 0.1 to 5 mass % of water, the solvency of the solvent in the system greatly improves, and the flowability and the lubricity greatly improve as well.

It is speculated that the above-described advantageous effects are combined effects of the functions (1) to (3) below.

(1) An ether group derived from the glycol ether-based organic solvent (c1), an ether group derived from the polyurethane resin (b1), and the water become solvated through hydrogen bonding.

(2) The presence of the water suppresses coagulation of the polyurethane resin (b1) that could arise through urethane bonding or hydrogen bonding derived from urea bonding of the polyurethane resin (b1).

(3) The vinyl chloride copolymer resin (b2) promotes the dispersion of pigments to stabilize the pigment dispersion.

These explanations are merely based on a speculation and do not limit the invention in any way.

Hereinafter, the solvent-type gravure ink for a laminate according to the present invention may be shortened to “the gravure ink” or “the ink” in some cases.

### <Pigment (A)>

According to the present invention, either of an inorganic pigment and an organic pigment can be used for the pigment (A).

There is no particular limitation on the organic pigment, and examples include soluble azo-based organic pigment, insoluble azo-based organic pigment, azo-based organic pigment, phthalocyanine-based organic pigment, halogenated phthalocyanine-based organic pigment, anthraquinone-based organic pigment, ansanthrone-based organic pigment, dianthraquinonyl-based organic pigment, anthrapyrimidine-based organic pigment, perylene-based organic pigment, perinone-based organic pigment, quinacridone-based organic pigment, thioindigo-based organic pigment, dioxazine-based organic pigment, isoindolinone-based organic pigment, quinophthalone-based organic pigment, azomethine azo-based organic pigment, flavanthrone-based organic pigment, diketopyrrolopyrrole-based organic pigment, isoindoline-based organic pigment, indanthrone-based organic pigment, and carbon black-based organic pigment. Examples of the above include Carmine 6B, Lake Red C, Permanent Red 2B, Disazo Yellow, Pyrazolone Orange, Carmine FB, Chromophthal Yellow, Chromophthal Red, Phthalocyanine Blue, Phthalocyanine Green, Dioxazine Violet, Quinacridone Magenta, Quinacridone Red, Indanthrone Blue, Pyrimidine Yellow, Thioindigo Bordeaux, Thioindigo Magenta, Perylene Red, Perinone Orange, Isoindolinone Yellow, Aniline Black, Diketopyrrolopyrrole Red, and Daylight Fluorescent Pigment.

Suitable specific examples of the organic pigment are indicated below in generic names of the color indices. It is preferable that the organic pigment include at least one selected from the group consisting of a black pigment, an indigo pigment, a green pigment, a red pigment, a violet pigment, a yellow pigment, an orange pigment, and a brown pigment. Furthermore, it is preferable that the organic pigment include at least one selected from the group consisting of the black pigment, the indigo pigment, the red pigment, and the yellow pigment. To effectively manifest the advantageous effects, it is particularly preferable to include at least one selected from the group consisting of the indigo pigment and the red pigment.

### <Black Pigment>

Specifically, among the black pigments of C.I. Pigment Black 1 to 34, a black pigment of an organic compound or an organic metal complex is preferable. Examples include C.I. Pigment Black 1, C.I. Pigment Black 6, C.I. Pigment Black 7, C.I. Pigment Black 9, and C.I. Pigment Black 20.

### <Indigo Pigment>

Specifically, among the indigo pigments of C.I. Pigment Blue 1 to 80, an indigo pigment of an organic compound or an organic metal complex is preferable. Examples include C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, C.I. Pigment Blue 16, C.I. Pigment Blue 17:1, C.I. Pigment Blue 22, C.I. Pigment Blue 24:1, C.I. Pigment Blue 25, C.I. Pigment Blue 26, C.I. Pigment Blue 60, C.I. Pigment Blue 61, C.I. Pigment Blue 62, C.I. Pigment Blue 63, C.I. Pigment Blue 64, C.I. Pigment Blue 75, C.I. Pigment Blue 79, and C.I. Pigment Blue 80.

### <Green Pigment>

Specifically, among the green pigments of C.I. Pigment Green 1 to 50, a green pigment of an organic compound or an organic metal complex is preferable. Examples include C.I. Pigment Green 1, C.I. Pigment Green 4, C.I. Pigment Green 7, C.I. Pigment Green 8, C.I. Pigment Green 10, and C.I. Pigment Green 36.

### <Red Pigment>

Specifically, among the red pigments of C.I. Pigment Red 1 to 279, a red pigment of an organic compound or an organic metal complex is preferable. Examples include C.I. Pigment Red 1 to C.I. Pigment Red 12, C.I. Pigment Red 15, C.I. Pigment Red 16, C.I. Pigment Red 17, C.I. Pigment Red 18, C.I. Pigment Red 19, C.I. Pigment Red 20, C.I. Pigment Red 21, C.I. Pigment Red 22, C.I. Pigment Red 23, C.I. Pigment Red 31, C.I. Pigment Red 32, C.I. Pigment Red 38, C.I. Pigment Red 41, C.I. Pigment Red 43, C.I. Pigment Red 46, C.I. Pigment Red 48, C.I. Pigment Red 48:1, C.I. Pigment Red 48:2, C.I. Pigment Red 48:3, C.I. Pigment Red 48:4, C.I. Pigment Red 48:5, C.I. Pigment Red 48:6, C.I. Pigment Red 49, C.I. Pigment Red 49:1, C.I. Pigment Red 49:2, C.I. Pigment Red 49:3, C.I. Pigment Red 52, C.I. Pigment Red 52:1, C.I. Pigment Red 52:2, C.I. Pigment Red 53, C.I. Pigment Red 53:1, C.I. Pigment Red 53:2, C.I. Pigment Red 53:3, C.I. Pigment Red 54, C.I. Pigment Red 57, C.I. Pigment Red 57:1, C.I. Pigment Red 58, C.I. Pigment Red 58:1, C.I. Pigment Red 58:2, C.I. Pigment Red 58:3, C.I. Pigment Red 58:4, C.I. Pigment Red 60:1, C.I. Pigment Red 63, C.I. Pigment Red 63:1, C.I. Pigment Red 63:2, C.I. Pigment Red 63:3, C.I. Pigment Red 64:1, C.I. Pigment Red 68, C.I. Pigment Red 68, C.I. Pigment Red 81:1, C.I. Pigment Red 83, C.I. Pigment Red 88, C.I. Pigment Red 89, C.I. Pigment Red 95, C.I. Pigment Red 112, C.I. Pigment Red 114, C.I. Pigment Red 119, C.I. Pigment Red 122, C.I. Pigment Red 123, C.I. Pigment Red 136, C.I. Pigment Red 144, C.I. Pigment Red 146, C.I. Pigment Red 147, C.I. Pigment Red 149, C.I. Pigment Red 150, C.I. Pigment Red 164, C.I. Pigment Red 166, C.I. Pigment Red 168, C.I. Pigment Red 169, C.I. Pigment Red 170, C.I. Pigment Red 171, C.I. Pigment Red 172, C.I. Pigment Red 175, C.I. Pigment Red 176, C.I. Pigment Red 177, C.I. Pigment Red 178, C.I. Pigment Red 179, C.I. Pigment Red 180, C.I. Pigment Red 181, C.I. Pigment Red 182, C.I. Pigment Red 183, C.I. Pigment Red 184, C.I. Pigment Red 185, C.I. Pigment Red 187, C.I. Pigment Red 188, C.I. Pigment Red 190, C.I. Pigment Red 192, C.I. Pigment Red 193, C.I. Pigment Red 194, C.I. Pigment Red 200, C.I. Pigment Red 202, C.I. Pigment Red 206, C.I. Pigment Red 207, C.I. Pigment Red 208, C.I. Pigment Red 209, C.I. Pigment Red 210, C.I. Pigment Red 211, C.I. Pigment Red 213, C.I. Pigment Red 214, C.I. Pigment Red 216, C.I. Pigment Red 215, C.I. Pigment Red 216, C.I. Pigment Red 220, C.I. Pigment Red 221, C.I. Pigment Red 223, C.I. Pigment Red 224, C.I. Pigment Red 226, C.I. Pigment Red 237, C.I. Pigment Red 238, C.I. Pigment Red 239, C.I. Pigment Red 240, C.I. Pigment Red 242, C.I. Pigment Red 245, C.I. Pigment Red 247, C.I. Pigment Red 248, C.I. Pigment Red 251, C.I. Pigment Red 253, C.I. Pigment Red 254, C.I. Pigment Red 255, C.I. Pigment Red 256, C.I. Pigment Red 257, C.I. Pigment Red 258, C.I. Pigment Red 260, C.I. Pigment Red 262, C.I. Pigment Red 263, C.I. Pigment Red 264, C.I. Pigment Red 266, C.I. Pigment Red 268, C.I. Pigment Red 269, C.I. Pigment Red 270, C.I. Pigment Red 271, C.I. Pigment Red 272, and C.I. Pigment Red 279.

### <Violet Pigment>

Specifically, among the violet pigments of C.I. Pigment Violet 1 to 50, a violet pigment of an organic compound or an organic metal complex is preferable. Examples include C.I. Pigment Violet 1, C.I. Pigment Violet 2, C.I. Pigment Violet 3, C.I. Pigment Violet 3:1, C.I. Pigment Violet 3:3, C.I. Pigment Violet 5:1, C.I. Pigment Violet 13, C.I. Pigment Violet 19 (γ-type, β-type), C.I. Pigment Violet 23, C.I. Pigment Violet 25, C.I. Pigment Violet 27, C.I. Pigment Violet 29, C.I. Pigment Violet 31, C.I. Pigment Violet 32, C.I. Pigment Violet 36, C.I. Pigment Violet 37, C.I. Pigment Violet 38, C.I. Pigment Violet 42, and C.I. Pigment Violet 50.

### <Yellow Pigment>

Specifically, among the yellow pigments of C.I. Pigment Yellow 1 to 219, a yellow pigment of an organic compound or an organic metal complex is preferable. Examples include C.I. Pigment Yellow 1, C.I. Pigment Yellow 3, C.I. Pigment Yellow 12, C.I. Pigment Yellow 13, C.I. Pigment Yellow 14, Pigment Yellow 17, C.I. Pigment Yellow 24, C.I. Pigment Yellow 42, C.I. Pigment Yellow 55, C.I. Pigment Yellow 62, C.I. Pigment Yellow 65, C.I. Pigment Yellow 74, C.I. Pigment Yellow 83, C.I. Pigment Yellow 86, C.I. Pigment Yellow 93, C.I. Pigment Yellow 94, C.I. Pigment Yellow 95, C.I. Pigment Yellow 109, C.I. Pigment Yellow 110, C.I. Pigment Yellow 117, C.I. Pigment Yellow 120, Pigment Yellow 125, C.I. Pigment Yellow 128, C.I. Pigment Yellow 129, C.I. Pigment Yellow 137, C.I. Pigment Yellow 138, C.I. Pigment Yellow 139, C.I. Pigment Yellow 147, C.I. Pigment Yellow 148, C.I. Pigment Yellow 150, C.I. Pigment Yellow 151, C.I. Pigment Yellow 153, C.I. Pigment Yellow 154, C.I. Pigment Yellow 155, C.I. Pigment Yellow 166, C.I. Pigment Yellow 168, C.I. Pigment Yellow 174, C.I. Pigment Yellow 180, C.I. Pigment Yellow 185, and C.I. Pigment Yellow 213.

### <Orange Pigment>

Specifically, among the orange pigments of C.I. Pigment Orange 1 to 81, an orange pigment of an organic compound or an organic metal complex is preferable. Examples include C.I. Pigment Orange 5, C.I. Pigment Orange 13, C.I. Pigment Orange 16, C.I. Pigment Orange 34, C.I. Pigment Orange 36, C.I. Pigment Orange 37, C.I. Pigment Orange 38, C.I. Pigment Orange 43, C.I. Pigment Orange 51, C.I. Pigment Orange 55, C.I. Pigment Orange 59, C.I. Pigment Orange 61, C.I. Pigment Orange 64, C.I. Pigment Orange 71, and C.I. Pigment Orange 74.

### <Brown Pigment>

Examples include C.I. Pigment Brown 23, C.I. Pigment Brown 25, and C.I. Pigment Brown 26.

Among the above, C.I. Pigment Red 57:1, C.I. Pigment Red 48:1, C.I. Pigment Red 48:2, C.I. Pigment Red 48:3, C.I. Pigment Red 146, C.I. Pigment Red 242, C.I. Pigment Yellow 83, C.I. Pigment Yellow 14, C.I. Pigment Orange 38, C.I. Pigment Orange 13, C.I. Pigment Yellow 180, C.I. Pigment Yellow 139, C.I. Pigment Red 185, C.I. Pigment Red 122, C.I. Pigment Red 178, C.I. Pigment Red 149, C.I. Pigment Red 144, C.I. Pigment Red 166, C.I. Pigment Violet 23, C.I. Pigment Violet 37, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:6, C.I. Pigment Green 7, C.I. Pigment Orange 34, C.I. Pigment Orange 64, C.I. Pigment Black 7, and so on are preferable. It is preferable to use at least one organic pigment selected from the above groups.

Examples of the inorganic pigment include a white inorganic pigment, such as titanium oxide, zinc oxide, zinc sulfide, barium sulfate, calcium carbonate, chromium oxide, or silica, and titanium oxide is particularly preferable. Titanium oxide provides white color and is preferable in terms of coloring power, concealing power, chemical resistance, and weatherability. From the viewpoint of printing performance, titanium oxide is preferably subjected to surface treatment with silica and/or alumina or the like.

Examples of the inorganic pigment other than a white inorganic pigment include aluminum particle, mica, bronze powder, chrome vermilion, chrome yellow, cadmium yellow, cadmium red, ultramarine blue, iron blue, red oxide, yellow iron oxide, and iron black. Examples of the state of aluminum include powder and paste, and paste is preferable from the viewpoint of ease of handling and safety. Leafing or non-leafing is selected as appropriate from the viewpoint of luminousness and the density.

In one aspect that further provides the effects of the present invention, at least one organic pigment including an azo lake pigment can be used as the pigment (A). The azo lake pigment is a mode in which an azo dye is turned into a pigment as a metallic salt. Therefore, the azo lake pigment typically lacks stability and is highly polar to easily deposit. Thus, a decrease in the ink stability and a decrease in the printability associated with the decrease in the ink stability (wear of a doctor blade, a filming phenomenon, etc.) tend to be more prominent in the azo lake pigment than in other pigments. According to the present invention, even when the azo lake pigment is used, the ink stability improves, and the printability can be improved.

Listed below are examples of the azo lake pigment.

Examples of a yellow azo lake pigment include C.I. Pigment Yellow 62, C.I. Pigment Yellow 133, C.I. Pigment Yellow 168, C.I. Pigment Yellow 169, C.I. Pigment Yellow 183, C.I. Pigment Yellow 191, C.I. Pigment Yellow 206, C.I. Pigment Yellow 209, C.I. Pigment Yellow 209:1, and C.I. Pigment Yellow 212.

Examples of an orange azo lake pigment include C.I. Pigment Orange 17 and C.I. Pigment Orange 46.

Examples of a red azo lake pigment include C.I. Pigment Red 48, C.I. Pigment Red 48:1, C.I. Pigment Red 48:2, C.I. Pigment Red 48:3, C.I. Pigment Red 48:4, C.I. Pigment Red 48:5, C.I. Pigment Red 49, C.I. Pigment Red 49:1, C.I. Pigment Red 49:2, C.I. Pigment Red 49:3, C.I. Pigment Red 52, C.I. Pigment Red 52:1, C.I. Pigment Red 52:2, C.I. Pigment Red 53, C.I. Pigment Red 53:1, C.I. Pigment Red 53:2, C.I. Pigment Red 53:3, C.I. Pigment Red 57, C.I. Pigment Red 57:1, C.I. Pigment Red 58, C.I. Pigment Red 58:1, C.I. Pigment Red 58:2, C.I. Pigment Red 58:3, C.I. Pigment Red 58:4, C.I. Pigment Red 60:1, C.I. Pigment Red 63, C.I. Pigment Red 63:1, C.I. Pigment Red 63:2, C.I. Pigment Red 63:3, C.I. Pigment Red 64:1, C.I. Pigment Red 68, C.I. Pigment Red 81:1, C.I. Pigment Red 83, C.I. Pigment Red 193, C.I. Pigment Red 200, and C.I. Pigment Red 211.

Examples of a violet azo lake pigment include C.I. Pigment Violet 1, C.I. Pigment Violet 2, C.I. Pigment Violet 3:1, C.I. Pigment Violet 3:3, C.I. Pigment Violet 5:1, and C.I. Pigment Violet 27.

To further provide the effects of the present invention, the pigment (A) can include at least one azo lake pigment selected from the group consisting of C.I. Pigment Red 48, C.I. Pigment Red 48:1, C.I. Pigment Red 48:2, C.I. Pigment Red 48:3, C.I. Pigment Red 48:4, C.I. Pigment Red 48:5, C.I. Pigment Red 49, C.I. Pigment Red 49:1, C.I. Pigment Red 49:2, C.I. Pigment Red 49:3, C.I. Pigment Red 52, C.I. Pigment Red 52:1, C.I. Pigment Red 52:2, C.I. Pigment Red 53, C.I. Pigment Red 53:1, C.I. Pigment Red 53:2, C.I. Pigment Red 53:3, C.I. Pigment Red 57, C.I. Pigment Red 57:1, C.I. Pigment Red 58, C.I. Pigment Red 58:1, C.I. Pigment Red 58:2, C.I. Pigment Red 58:3, and C.I. Pigment Red 58:4.

In another aspect that further provides the effects of the present invention, at least one organic pigment including a phthalocyanine pigment can be used as the pigment (A). Examples of the phthalocyanine pigment include Phthalocyanine Blue and Phthalocyanine Green.

Examples of Phthalocyanine Blue include, among the indigo pigment of C.I. Pigment Blue 1 to 80, an indigo pigment or the like of an organic compound or an organic metal complex. Specific examples include C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:5, C.I. Pigment Blue 15:6, C.I. Pigment Blue 16, C.I. Pigment Blue 17:1, C.I. Pigment Blue 75, and C.I. Pigment Blue 79.

In yet another aspect that further provides the effects of the present invention, at least one inorganic pigment including a titanium oxide pigment can be used as the pigment (A).

The crystal structure of the titanium oxide pigment may be any one of an anatase type, a rutile type, and a brookite type. Among the above, rutile-type titanium oxide is preferable for its high pigment dispersiveness. In industrial production of titanium oxide, rutile ore or ilmenite ore (FeTiO₃) is typically used as a source material. There are two main manufacturing methods: a chlorine method and a sulfuric acid method, and either method may be used.

To improve the printability in gravure printing, the titanium oxide pigment is preferably surface-treated. In particular, the titanium oxide pigment is preferably surface-treated with at least one metal or metal oxide selected from Si, Al, Zn, Zr, and oxides thereof. The titanium oxide pigment is particularly preferably at least a rutile-type titanium oxide surface-treated with at least one metal oxide selected from the group consisting of silica and alumina.

An amount of oil absorption of the titanium oxide pigment measured in accordance with a measuring method defined in JIS K5101 is preferably 14 to 35 ml/100 g or more preferably 17 to 32 ml/100 g. The mean particle size (median particle size) measured with a transmission electron microscope is preferably 0.2 to 0.3 μm. The content of the titanium oxide pigment is preferably 10 to 60 mass % or more preferably 10 to 45 mass % in 100 mass % of the ink. A plurality of types of titanium oxide pigments may be used in combination.

It is preferable that the pigment (A) be included in an amount sufficient to achieve suitable density and coloring power of the solvent-type gravure ink for a laminate. Specifically, it is preferable that the pigment (A) be included at a proportion of 1 to 50 mass % with respect to the total amount of the ink composition or at a proportion of 10 to 90 mass % of the solid content of the ink composition. One of the pigments alone or a combination of two or more of the pigments can be used. In the present specification, the “solid content” refers to a total nonvolatile component excluding liquid, such as an organic solvent and water.

The solvent-type gravure ink for a laminate according to the present invention can be used for printing upon being combined with an ink composition of another hue, as necessary. Examples of the colors of the ink include a total of five basic colors: yellow, magenta, indigo, and jet-black. Examples of extended gamut process colors include red (orange), grass (green), violet, transparent yellow, purple, vermilion, brown, and pearl.

### <Binder Resin (B)>

The solvent-type gravure ink for a laminate according to the present invention includes, as the binder resin (B), at least 80 to 100 mass % in total of the polyurethane resin (b1) and the vinyl chloride copolymer resin (b2) in 100 mass % of the binder resin (B). The mass ratio of the resin (b1) and the resin (b2) is (b1):(b2)=95:5 to 40:60.

Examples of the binder resin that can be used in combination as necessary include acrylic resin, polyester resin, styrene resin, styrene-maleic acid resin, maleic acid resin, polyamide resin, and cellulose resin. One or more of the above can be used in combination.

<Polyurethane Resin (b1)>

The polyurethane resin (b1) includes 1 to 50 mass % of a structural unit derived from a polyether. There is no particular limitation on the polyether, and examples include polyether polyol and polyether polyamine. Polyether polyol is preferable. When the content of the structural unit derived from a polyether is no less than 1 mass %, high solubility traceable to a combined effect with the glycol ether-based organic solvent (c1) is manifested. When the content is no greater than 50 mass %, high anti-blocking performance of a coat of ink is obtained. The content of the structural unit derived from a polyether is more preferably 2 to 40 mass % or particularly preferably 3 to 30 mass %.

In the present specification, the content of the structural unit derived from a polyether is the mass percentage of the structural unit derived from a polyether with respect to 100 mass % of the solid content of the polyurethane resin (b1).

The weight-average molecular weight of the polyurethane resin (b1) is preferably 10,000 to 100,000. The glass transition temperature thereof is preferably −60° C. to 40° C. The elastic storage modulus at 40° C. in a dynamic viscoelasticity measurement is preferably 1 to 100 MPa. In the present specification, the glass transition temperature is measured with the use of a differential scanning calorimeter (DSC) and indicates a midpoint within a temperature range in which a glass transition occurs.

The polyurethane resin (b1) preferably has an amino group and/or a hydroxyl value. The amine value is preferably 1.0 to 20.0 mgKOH/g. The hydroxyl value is preferably 1.0 to 20.0 mgKOH/g.

The polyurethane resin (b1) preferably includes a structural unit derived from a polyester polyol. The content of this structural unit is preferably 5 to 80 mass % or more preferably 30 to 70 mass % in 100 mass % of the solid content of the polyurethane resin (b1).

The polyurethane resin (b1) is manufactured as appropriate through a well-known method. Preferable examples of the polyurethane resin (b1) include a polyurethane resin obtained from a polyol and a polyisocyanate, and a polyurethane resin obtained through a reaction of an amine-based chain extender and an isocyanate-terminated urethane polymer obtained from a polyol and a polyisocyanate.

Examples of the polyol include polyester polyol, polyether polyol, polycaprolactone diol, polycarbonate polyol, polyolefin polyol, castor oil polyol, hydrogenated castor oil polyol, dimer diol, and hydrogenated dimer diol. Among the above, polyether polyol and polyester polyol are preferable. Specifically, the polyurethane resin (b1) that contains a polyether structure derived from a polyether polyol and/or a polyester structure derived from a polyester polyol is particularly preferable.

A low-molecular-weight diol may be used in combination in manufacturing the polyurethane resin (b1). The molecular weight of the low-molecular-weight diol is preferably 50 to 800, and examples include ethylene glycol, diethylene glycol, triethylene glycol, propylene glycol, 1,3-propanediol, 1,4-butanediol, 1,3-butanediol, 1,6-hexanediol, 1,8-octanediol, 1,9-nonanediol, neopentyl glycol, 3-methyl-1,5-pentanediol, 2-methyl-1,3-propanediol, 3,3,5-trimethyl pentanediol, 2,4-diethyl-1,5-pentanediol, 1,12-octadecanediol, 1,2-alkanediol, 1,3-alkanediol, 1-monoglyceride, 2-monoglyceride, 1-monoglycerol ether, 2-monoglycerol ether, dimer diol, and hydrogenated dimer diol.

Examples of the polyether polyol include a polyether polyol that is a (co)polymer of ethylene oxide, propylene oxide, tetrahydrofuran, or the like. In particular, polytetramethylene glycol, polypropylene glycol, and polyethylene glycol are preferable. It is preferable that the number-average molecular weight be 500 to 10,000. The number-average molecular weight can be calculated from the hydroxyl value since the terminals are hydroxyl groups and can be obtained through the expression (1).

number-average molecular weight of polyol=1000×56.1×valence of hydroxyl group/hydroxyl value Expression (1):

Examples of the polyester polyol include a condensate obtained through an esterification reaction of a dibasic acid and a diol. Examples of the dibasic acid include adipic acid, phthalic anhydride, isophthalic acid, terephthalic acid, maleic acid, fumaric acid, succinic acid, oxalic acid, malonic acid, pimelic acid, azelaic acid, sebacic acid, suberic acid, glutaric acid, 1,4-cyclohexyldicarboxylic acid, dimer acid, and hydrogenated dimer acid. Examples of the diol include ethylene glycol, diethylene glycol, triethylene glycol, propylene glycol, 1,3-propanediol, 1,4-butanediol, 1,3-butanediol, 1,6-hexanediol, 1,8-octanediol, 1,9-nonanediol, neopentyl glycol, 3-methyl-1,5-pentanediol, 2-methyl-1,3-propanediol, 3,3,5-trimethyl pentanediol, 2,4-diethyl-1,5-pentanediol, 1,12-octadecanediol, 1,2-alkanediol, 1,3-alkanediol, 1-monoglyceride, 2-monoglyceride, 1-monoglycerol ether, 2-monoglycerol ether, dimer diol, and hydrogenated dimer diol.

One of the polyester polyols alone or a combination of two or more of the polyester polyols can be used.

Among the above, a polyester polyol obtained from a diol having a branched structure and a dibasic acid is preferable. The diol having a branched structure is a diol having an alkyl side chain in which at least one of the hydrogen atoms of an alkylene group included in the diol is substituted with an alkyl group. Examples include propylene glycol, 1,3-butanediol, 2-methyl-1,3-propanediol, neopentyl glycol, 1,4-pentanediol, 3-methyl-1,5-pentanediol, 2,5-hexanediol, 2-methyl-1,4-pentanediol, 2,4-diethyl-1,5-pentanediol, 2-butyl-2-ethyl-1,3-propanediol, 2-methyl-1,8-octanediol, 2,2,4-trimethyl-1,3-pentanediol, and 2,2,4-trimethyl-1,6-hexanediol. These are particularly preferable for improving the printability, the printing performance, and the lamination strength. Particularly preferable examples of the dibasic acid include sebacic acid and/or adipic acid. In addition, a polyol having three or more hydroxyl groups and/or a polyvalent carboxylic acid having three or more carboxy groups can also be used in combination.

The polyester polyol preferably has a number-average molecular weight of 500 to 10,000. The number-average molecular weight can be obtained through the expression (1) above. The polyester polyol has an acid value of preferably no greater than 1.0 mgKOH/g or more preferably no greater than 0.5 mgKOH/g.

A well-known polyisocyanate can be used, and examples include aromatic diisocyanate, aliphatic diisocyanate, and alicyclic diisocyanate.

Examples of the aromatic diisocyanate include 1,5-naphthylene diisocyanate, 4,4′-diphenylmethane diisocyanate (MDI), 4,4′-diphenyldimethylmethane diisocyanate, 4,4′-dibenzyl isocyanate, dialkyl diphenylmethane diisocyanate, tetraalkyl diphenylmethane diisocyanate, 1,3-phenylene diisocyanate, m-tetramethylxylylene diisocyanate, 1,4-phenylene diisocyanate, and tolylene diisocyanate.

Examples of the aliphatic diisocyanate include butane-1,4-diisocyanate, hexamethylene diisocyanate, isopropylene diisocyanate, methylene diisocyanate, 2,2,4-trimethylhexamethylene diisocyanate, and lysine diisocyanate.

Examples of the alicyclic diisocyanate include cyclohexane-1,4-diisocyanate, hydrogenated xylylene diisocyanate, isophorone diisocyanate, dimeryl diisocyanate, dicyclohexylmethane-4,4′-diisocyanate, 1,3-bis(isocyanatemethyl)cyclohexane, methylcyclohexane diisocyanate, norbornane diisocyanate, and dimer diisocyanate in which a carboxy group of a dimer acid is converted to an isocyanate group.

Among the above, the aromatic diisocyanate and/or the alicyclic diisocyanate are/is preferable.

Among the compounds listed above as examples, an isocyanurate form of tolylene diisocyanate, isophorone diisocyanate, xylylene diisocyanate, hydrogenated xylylene diisocyanate, hexamethylene diisocyanate, or hexamethylene diisocyanate, and so on are preferable.

These polyisocyanates may form a trimer to have an isocyanurate ring structure. One of these polyisocyanates alone or a combination of two or more of these polyisocyanates can be used.

There is no particular limitation on the amine-based chain extender, and an amine-based chain extender having a molecular weight of no greater than 500 is preferable. Examples include a diamine-based chain extender and a trifunctional or higher polyfunctional amine-based chain extender.

Examples include a diamine-based chain extender, such as ethylene diamine, propylene diamine, hexamethylene diamine, pentamethylene diamine, isophorone diamine, dicyclohexylmethane-4,4′-diamine, or p-phenylene diamine;

a diamine-based chain extender having a hydroxyl group, such as 2-hydroxyethyl ethylene diamine, 2-hydroxyethyl propyl diamine, 2-hydroxyethyl propylene diamine, di-2-hydroxyethyl ethylene diamine, di-2-hydroxy ethylene diamine, di-2-hydroxyethyl propylene diamine, 2-hydroxypropyl ethylene diamine, di-2-hydroxypropyl ethylene diamine, or di-2-hydroxypropyl ethylene diamine; and

a trifunctional or higher polyfunctional amine-based chain extender, such as diethylene triamine, iminobispropylamine (IBPA, 3,3′-diaminodipropylamine), triethylene tetramine, N-(3-aminopropyl)butane-1,4-diamine(spermidine), 6,6-iminodihexylamine, 3,7-diazononane-1,9-diamine, or N,N′-bis(3-aminopropyl)ethylene diamine.

One of these chain extenders alone or a combination of two or more of these chain extenders can be used. Among the above, preferable examples include isophorone diamine, hexamethylene diamine, and iminobispropylamine.

In addition, if necessary, a monovalent active hydrogen compound can be used as a polymerization terminator to terminate overreaction. There is no particular limitation on such a compound as long as this compound is, for example, a monoamine compound having a primary or secondary amino group, and examples include dialkyl amines, such as di-n-butylamine, and amino alcohols, such as 2-ethanolamine. Furthermore, when a carboxy group is to be introduced into the polyurethane resin in particular, an amino acid, such as glycine or L-alanine, can be used as a polymerization terminator. When a polymerization terminator is to be used, a polymerization terminator and a chain extender may be used together to carry out a chain extending reaction, or a polymerization terminator alone may be added after a chain extending reaction has been carried out by a chain extender to a certain level to carry out a polymerization terminating reaction. Meanwhile, the molecular weight can be controlled even when the polymerization terminator is not used. In this case, a method in which a prepolymer is added to a solution including a chain extender is preferable in terms of reaction control Amino alcohol is preferable as the polymerization terminator, and it is preferable to use 0.01 to 2.0 mass % of amino alcohol with respect to 100 mass % of the polyurethane resin (b1).

As a method of synthesizing the polyurethane resin (b1), a prepolymer method is preferable in which a polyol and a polyisocyanate are allowed to react to obtain a prepolymer having an isocyanate group at a terminal and this prepolymer is allowed to react with an amine-based chain extender and, if necessary, a polymerization terminator to synthesize the polyurethane resin. For example, a prepolymer method is preferable in which a polyol and a polyisocyanate are allowed to react (urethanation reaction) at a temperature of 50° C. to 150° C. with the use of, if necessary, a solvent inert to an isocyanate group and further with the use of, if necessary, a urethanation catalyst to obtain a prepolymer having an isocyanate group at a terminal and this prepolymer is then allowed to react with an amine-based chain extender and, if necessary, a polymerization terminator to obtain the polyurethane resin.

Other synthesizing methods include a so-called one-shot method in which a polymer polyol, a polyisocyanate, an amine-based chain extender, and, if necessary, a polymerization terminator are allowed to reach in one shot to obtain the polyurethane resin.

In manufacturing the prepolymer, it is preferable to determine the amounts of a polyol and a polyisocyanate such that the NCO/OH ratio, which is the ratio of the number of moles of the isocyanate group in the polyisocyanate and the total number of moles of the hydroxyl group in the polyol, is within a range of 1.1 to 3.0. More preferably, the NCO/OH ratio is 1.3 to 2.5.

From the viewpoint of reaction control, it is preferable to use an organic solvent in synthesizing the prepolymer. As the organic solvent, an organic solvent inert to an isocyanate group is preferable. Examples include ketones, such as acetone, methyl ethyl ketone, methyl isobutyl ketone, and cyclohexanone; ethers, such as dioxane and tetrahydrofuran; and esters, such as ethyl acetate, butyl acetate, and propyl acetate. One of the above alone or a combination of two or more of the above can be used.

A catalyst can be used, if necessary, in the synthesizing reaction of the prepolymer. Examples of the catalyst include a tertiary amine-based catalyst, such as triethylamine or dimethylaniline; and a metal-based catalyst, such as tin or zinc. These catalysts are used typically within a range of 0.001 to 1 mol % with respect to a polyol compound.

The prepolymer having an isocyanate group at a terminal is allowed to react with diamine, triamine, or the like, which is an amine-based chain extender, at 10° C. to 60° C., and a high-molecular-weight polyurethane resin (b1) containing an active hydrogen group at a terminal is obtained.

The reaction is carried out preferably such that the ratio of the total number of moles of the amino group in the amine-based chain extender to the number of moles of the isocyanate group in the prepolymer is in a range of 1.01 to 2.00 or preferably 1.03 to 1.06.

<Vinyl Chloride Copolymer Resin (b2)>

There is no particular limitation on the vinyl chloride copolymer resin (b2), and examples include vinyl chloride-vinyl acetate copolymer resin and vinyl chloride-acrylic copolymer resin. To improve the solubility into the organic solvent (C), a vinyl chloride-vinyl acetate copolymer resin having a hydroxyl group and a vinyl chloride-acrylic copolymer resin having a hydroxyl group are particularly preferable. Using the vinyl chloride copolymer resin (b2) having a hydroxyl group in combination when the pigment is dispersed makes it possible to obtain a pigment dispersion that excels in dissolving stability and dispersion stability, as compared to a case in which the polyurethane resin (b1) alone is used to disperse the pigment.

In the solvent-type gravure ink for a laminate according to the present invention, the mass ratio (b1):(b2) of the polyurethane resin (b1) and the vinyl chloride copolymer resin (b2) having a hydroxyl group is 95:5 to 40:60. When the mass ratio is within this range, the dispersiveness of the pigment improves. The mass ratio is preferably 90:10 to 50:50 or more preferably 90:10 to 60:40. When the mass ratio is within the stated ranges, excellent pigment dispersion stability, excellent printability, excellent substrate adhesiveness, excellent film coating properties, and high lamination strength can be obtained.

### <Vinyl Chloride-Vinyl Acetate Copolymer Resin>

The vinyl chloride-vinyl acetate copolymer resin is a resin having, as a primary component, a copolymer of vinyl chloride and vinyl acetate. The weight-average molecular weight of the vinyl chloride-vinyl acetate copolymer resin is preferably 5,000 to 100,000 or more preferably 20,000 to 70,000. It is preferable that, in 100 mass % of the solid content of the vinyl chloride-vinyl acetate copolymer resin, the content of a structural unit derived from a vinyl acetate monomer be 1 to 30 mass % and the content of a structural unit derived from a vinyl chloride monomer be 70 to 95 mass %. In this case, the dispersiveness of the pigment improves, the solubility into the organic solvent improves, and excellent adhesiveness onto the substrate, excellent film properties, high lamination strength, and so on can be obtained.

As the vinyl chloride-vinyl acetate copolymer resin, a copolymer in which a monomer including a hydroxyl group is used is preferable, and the hydroxyl value is preferably 20 to 200 mgKOH/g. The glass transition temperature is preferably 50° C. to 90° C. Examples of the monomer including a hydroxyl group include vinylalcohol and hydroxyalkyl acrylate.

### <Vinyl Chloride-Acrylic Copolymer Resin>

The vinyl chloride-acrylic copolymer resin is a resin having, as a primary component, a copolymer of a vinyl chloride monomer and an acrylic monomer. The vinyl chloride-acrylic copolymer resin preferably contains a hydroxyl group in its structure. The acrylic monomer preferably includes a (meth)acrylic acid hydroxyalkyl ester to improve the adhesiveness onto the substrate and the solubility into the organic solvent. The acrylic monomer may be incorporated in a main chain of polyvinyl chloride in a block sequence or a random sequence or may be grafted on a side chain of polyvinyl chloride. The weight-average molecular weight of the vinyl chloride-acrylic copolymer resin having a hydroxyl group is preferably 10,000 to 100,000 or more preferably 30,000 to 70,000.

The content of a structural unit derived from the vinyl chloride monomer in the vinyl chloride-acrylic copolymer resin having a hydroxyl group is preferably 70 to 95 mass % in 100 mass % of the solid content of the vinyl chloride-acrylic copolymer resin having a hydroxyl group. In this case, the dispersiveness of the pigment improves, the solubility into the organic solvent improves, and excellent adhesiveness onto the substrate, excellent film properties, high lamination strength, and so on can be obtained. The vinyl chloride-acrylic copolymer resin is preferably a copolymer in which a monomer including a hydroxyl group is used, and the hydroxyl value is preferably 20 to 200 mgKOH/g.

In the present specification, “(meth)acryl” is a collective term for methacryl and acryl, and “(meth)acrylate” is a collective term for methacrylate and acrylate.

Examples of the acrylic monomer having a hydroxyl group include a (meth)acrylic acid hydroxyalkyl ester, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 6-hydroxyhexyl (meth)acrylate, or 8-hydroxyoctyl (meth)acrylate; glycol mono(meth)acrylate, such as polyethylene glycol mono(meth)acrylate, polypropylene glycol mono(meth)acrylate, or 1,4-cyclohexanedimethanol mono(meth)acrylate; caprolactone-modified (meth)acrylate; and hydroxyethyl acrylamide. One of the above alone or a combination of two or more of the above can be used.

In particular, a (meth)acrylic acid hydroxyalkyl ester is preferable, and the carbon number of the alkyl group is preferably 1 to 10. To improve the solubility into the solvent, 2-hydroxyethyl (meth)acrylate, 4-hydroxybutyl (meth)acrylate, and 2-hydroxypropyl acrylate are more preferable.

Examples of other acrylic monomers include a (meth)acrylic acid alkyl ester, and the carbon number of the alkyl group is preferably 1 to 10. Examples include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, tetradecyl (meth)acrylate, hexadecyl (meth)acrylate, and octadecyl (meth)acrylate. The alkyl group may have a benzene ring structure. One of the above alone or a combination of two or more of the above can be used.

The acrylic acid ester may have a functional group other than the hydroxyl group. Examples of the functional group include a carboxy group, an amide-bonding group, an amino group, and an alkylene oxide group.

Among the acrylic monomers, an acrylic acid ester having a hydroxyl group-containing alkyl group is preferable, and the carbon number thereof is preferably 2 to 10.

In 100 mass % of the solvent-type gravure ink for a laminate according to the present invention, the total amount (solid content amount) of the polyurethane resin (b1) and the vinyl chloride copolymer resin (b2) (preferably, a vinyl chloride copolymer resin (b2) having a hydroxyl group) is preferably 3.0 to 25.0 mass % or more preferably 4.0 to 18 mass %.

### <Organic Solvent (C)>

The gravure ink for a laminate according to the present invention includes the organic solvent (C) as a liquid medium. As the organic solvent (C), an aromatic organic solvent (so-called toluene-based organic solvent), such as toluene or xylene, is not preferable, and a non-aromatic organic solvent that includes no aromatic ring (so-called non-toluene-based organic solvent) is preferable. Examples of the non-aromatic organic solvent include a ketone-based organic solvent, such as methyl ethyl ketone or methyl isobutyl ketone; an ester-based organic solvent, such as ethyl acetate, n-propyl acetate, isopropyl acetate, or isobutyl acetate; and an alcohol-based organic solvent, such as methanol, ethanol, 1-propanol (also referred to as n-propanol), isopropanol, or n-butanol. One of the above alone or a combination of two or more of the above can be used. Among the above, an organic solvent (specifically, an ester-based organic solvent and/or an alcohol-based organic solvent) other than a ketone-based organic solvent such as methyl ethyl ketone (hereinafter, referred to as “MEK”) is more preferable, and a mixed organic solvent composed of an ester-based organic solvent and an alcohol-based organic solvent is most preferable.

When a mixed organic solvent composed of an ester-based organic solvent and an alcohol-based organic solvent is used, it is preferable that ester-based organic solvent:alcohol-based organic solvent (mass ratio) be 95:5 to 40:60. More preferably, the mass ratio is 90:10 to 50:50.

The alcohol-based organic solvent preferably includes 1-propanol and particularly preferably contains 0.5 to 10.0 mass % of 1-propanol in 100 mass % of the solvent-type gravure ink for a laminate.

<Glycol Ether-Based Organic Solvent (c1)>

The solvent-type gravure ink for a laminate according to the present invention contains 0.1 to 15 mass % of the glycol ether-based organic solvent (c1) in 100 mass % of the ink. When the solvent-type gravure ink contains the glycol ether-based organic solvent (c1) in the stated range in combination with water, the dissolving stability of the pigment dispersion in the ink improves. In addition, a whitening phenomenon in printing in a high-temperature, high-humidity environment can be suppressed. It is speculated that, although the whitening phenomenon occurs as the solvent rapidly absorbs the moisture in the environment when drying and vaporizing to crystallize or deposit, as the ink contains water and the glycol ether-based organic solvent (c1), the solvency of the pigment dispersion improves and thus whitening is less likely to occur. These advantageous effects are non-limiting. The content of the glycol ether-based organic solvent (c1) is preferably 0.5 to 10 mass % or more preferably 1.0 to 8 mass %.

Examples of the glycol ether-based organic solvent (c1) include ethylene glycol ethers, such as ethylene glycol monomethyl ether, ethylene glycol monoethyl ether, ethylene glycol dimethyl ether, ethylene glycol diethyl ether, ethylene glycol mono-n-propyl ether, ethylene glycol monoisopropyl ether, ethylene glycol dipropyl ether, ethylene glycol monobutyl ether, ethylene glycol monoisobutyl ether, ethylene glycol dibutyl ether, ethylene glycol isoamyl ether, ethylene glycol monohexyl ether, ethylene glycol mono-2-ethylhexyl ether, methoxyethoxy ethanol, and ethylene glycol monoaryl ether;

diethylene glycol ethers, such as diethylene glycol monomethyl ether, diethylene glycol monoethyl ether, diethylene glycol monoisopropyl ether, diethylene glycol monobutyl ether, diethylene glycol monoisobutyl ether, diethylene glycol dimethyl ether, diethylene glycol diethyl ether, diethylene glycol dibutyl ether, diethylene glycol monohexyl ether, and diethylene glycol mono-2-ethylhexyl ether;

triethylene glycol ethers, such as triethylene glycol monoethyl ether, triethylene glycol monomethyl ether, triethylene glycol monoisopropyl ether, triethylene glycol monobutyl ether, and triethylene glycol dimethyl ether;

propylene glycol ethers, such as propylene glycol monomethyl ether, propylene glycol monoethyl ether, propylene glycol monopropyl ether, propylene glycol monobutyl ether, and butoxypropanol;

dipropylene glycol ethers, such as dipropylene glycol monomethyl ether, dipropylene glycol monoethyl ether, dipropylene glycol monopropyl ether, and dipropylene glycol monobutyl ether; and

tripropylene glycol ethers, such as tripropylene glycol monomethyl ether.

One of the above alone or a combination of two or more of the above can be used.

The glycol ether-based organic solvent (c1) may be esterified, and one obtained by converting the above glycol monoether into acetate can be used preferably. Representative examples include ethylene glycol monomethyl ether acetate, ethylene glycol monoethyl ether acetate, ethylene glycol monobutyl ether acetate, diethylene glycol monoethyl ether acetate, diethylene glycol monobutyl ether acetate, propylene glycol monomethyl ether acetate, and propylene glycol monoethyl ether acetate.

As the glycol ether-based organic solvent (c1), at least one organic solvent selected from the group consisting of ethylene glycol ethers, dipropylene glycol ethers, propylene glycol ethers, and dipropylene glycol ethers is preferable.

Among the ethylene glycol ethers, ethylene glycol monoalkyl ether is preferable. Among the propylene glycol ethers, propylene glycol monoalkyl ether is preferable. The carbon number of the alkyl ether group in ethylene glycol monoalkyl ether and propylene glycol monoalkyl ether is preferably 1 to 4.

As ethylene glycol monoalkyl ether, ethylene glycol monopropyl ether and ethylene glycol mono(iso)propyl ether are more preferable. As propylene glycol monoalkyl ether, propylene glycol monomethyl ether is more preferable.

Either one of ethylene glycol monoalkyl ether and propylene glycol monoalkyl ether may be used alone, but it is more preferable to use the two in combination.

The glycol ether-based organic solvent (c1) preferably has a solubility parameter of 9.0 to 12.0, and when the solubility parameter is more preferably 9.0 to 11.0, the solubility of the pigment dispersion is maximized, which is thus preferable.

The solubility parameter (hereinafter, referred to as the SP value in some cases) in the present specification is expressed by the square root of the molecular cohesion energy and is a value (Hansen solubility parameter) obtained through the expression (2).

δ²=δ_{d}²+δₚ²+δₕ² Expression (2):

(In Expression (2), δ_{d} represents a contribution of the dispersion force, δₚ represents a contribution of the polar interaction, and δₕ represents a contribution of hydrogen bonding.)

The unit is (cal/cm³)^{1/2}, and this is a value at 25° C. The values of Hansen solubility parameters have been found for many solvents, and these values are, for example, in Polymer Handbook Fourth Edition, Chapter VII, Industrial Solvents Handbook written by Wesley L. Archer, and so on.

The solubility parameter can also be calculated through a method described in R. F. Fedors, Polymer Engineering Science, 14, p. 147 (1974). The formula is shown below as Expression (3). In Fedors' method of calculating the solubility parameter, both the cohesive energy density and the molar volume depend on the type and the number of the substituents.

δ=[ΣEcoh/ΣV]^{1/2} Expression (3):

(In the above, ΣEcoh represents the cohesive energy, and ΣV represents the molar volume.)

It is known that the Fedors solubility parameters coincide well with the Hansen solubility parameters.

The glycol ether-based organic solvent (c1) preferably has a boiling point of 110° C. to 240° C. More preferably, the boiling point is 110° C. to 200° C. There is no particular limitation on the glycol ether-based organic solvent (c1), and examples include the following organic solvents.

ethylene glycol monomethyl ether (SP value: 11.6 (cal/cm³)^{1/2}, boiling point: 124.5° C.)
diethylene glycol monomethyl ether (SP value: 10.7 (cal/cm³)^{1/2}, boiling point: 194.0° C.)
ethylene glycol mono-n-propyl ether (SP value: 9.8 (cal/cm³)^{1/2}, boiling point: 151.0° C.)
ethylene glycol monoisopropyl ether (SP value: 9.2 (cal/cm³)^{1/2}, boiling point: 141.8° C.)
ethylene glycol monobutyl ether (SP value: 9.8 (cal/cm³)^{1/2}, boiling point: 171.2° C.)
diethylene glycol monobutyl ether (SP value: 9.5 (cal/cm³)^{1/2}, boiling point: 230.6° C.)
propylene glycol monomethyl ether (SP value: 10.4 (cal/cm³)^{1/2}, boiling point: 121.0° C.)
dipropylene glycol monomethyl ether (SP value: 9.6 (cal/cm³)^{1/2}, boiling point: 187.2° C.)
propylene glycol mono-n-propyl ether (SP value: 9.4 (cal/cm³)^{1/2}, boiling point: 149.8° C.)

To promote an improvement in overprinting suitability (trapping performance), the surface tension measured through the du Nouy method (also referred to as a ring method) based on JIS K 2241 is preferably 22.0 to 30.0 mN/m. Furthermore, the glycol ether-based organic solvent (c1) is preferably water-soluble.

### <Water (D)>

The solvent-type gravure ink for a laminate according to the present invention includes 0.1 to 5 mass % of water in 100 mass % of the ink. As the solvent-type gravure ink includes water, coagulation of the polyurethane resin (b1) that could arise through urethane bonding or hydrogen bonding of urea bonding of the polyurethane resin (b1) is prevented, and the thickening of the gravure ink and the depositing of the solid content are suppressed. In addition, as water is used in combination with the glycol ether-based organic solvent (c1), the flowability and the lubricity of the ink itself improve. The effect of improved flowability and lubricity becomes prominent when the binder resin (B) includes the polyurethane resin (b1) and the vinyl chloride copolymer resin (b2).

As the solvent-type gravure ink includes no less than 0.1 mass % of water, the viscosity of the ink stabilizes, and the flowability improves. In addition, as the amount of water is no greater than 5 mass %, whitening in printing in a high-temperature, high-humidity environment can be suppressed. The content of the water is preferably 0.5 to 4 mass % in 100 mass % of the ink. There is no particular limitation on the timing at which the water is added, and the water may be added while the pigment is dispersed or after the pigment is dispersed.

<Other Resins that can be Used in Combination>

The solvent-type gravure ink for a laminate according to the present invention may contain other polymer materials, as necessary. Examples of the other polymer materials include chlorinated polypropylene resin, ethylene-vinyl acetate copolymer resin, vinyl acetate resin, alkyd resin, polyvinyl chloride resin, rosin-based resin, rosin-modified maleic acid resin, terpene resin, phenol-modified terpene resin, ketone resin, cyclized rubber, chlorinated rubber, butyral, petroleum resin, and modified resins of the above. One of these resins alone or a combination of two or more of these resins can be used. The content of such resin is preferably 1 to 20 mass % in 100 mass % of the solid resin content of the solvent-type gravure ink for a laminate.

### <Additive>

The solvent-type gravure ink for a laminate according to the present invention can include one or more well-known additives, as necessary. Examples of the well-known additives include a pigment derivative, an extender pigment, a dispersant, a wetting agent, an adhesion aid, a silica particle, a leveling agent, an antifoaming agent, an antistatic agent, a trapping agent, an anti-blocking agent, a wax component, an isocyanate-based curing agent, and a silane coupling agent.

For example, a dispersant can be used to disperse the pigment stably. As the dispersant, anionic, nonionic, cationic, or amphoteric surfactant can be used. From the viewpoint of preservation stability of ink, the content of the dispersant is preferably 0.1 to 10.0 mass % or more preferably 0.1 to 3.0 mass % with respect to 100 mass % of the total amount of the ink.

### <Manufacture of Solvent-Type Gravure Ink for Laminate>

The solvent-type gravure ink for a laminate according to the present invention can be manufactured by dissolving and/or dispersing the pigment (A), the polyurethane resin (b1), and the vinyl chloride copolymer resin (b2) (preferably, a vinyl chloride copolymer resin (b2) having a hydroxyl group) in the organic solvent (C) and the water (D). For example, the pigment, the polyurethane resin (b1), the vinyl chloride copolymer resin (b2) (preferably, a vinyl chloride copolymer resin (b2) having a hydroxyl group) and, if necessary, a dispersant are mixed, and this mixture is dispersed in the organic solvent (C) to obtain a pigment dispersion. The polyurethane resin (b1), the glycol ether-based solvent (c1), the water (D), and, if necessary, another resin and/or an additive or the like are further blended into the obtained pigment dispersion, and thus the solvent-type gravure ink for a laminate can be manufactured.

The granularity distribution of the pigment dispersion can be adjusted by controlling the size of a pulverizing medium of a disperser, the filling factor of the pulverizing medium, the dispersion treatment time, the discharge rate of the pigment dispersion, the viscosity of the pigment dispersion, and so on, as appropriate. As the disperser, a well-known disperser, such as a roller mill, a ball mill, a pebble mill, an attritor, or a sand mill, can be used.

When air bubbles, unexpected coarse particles, and so on are included in the ink, the quality of the printed material is reduced, and thus they are preferably removed through filtering. A conventionally known filter can be used.

### <Viscosity>

The viscosity of the solvent-type gravure ink for a laminate manufactured through the above-described method is preferably in a range of 40 to 500 cps at 25° C. as measured with a type B viscometer in order to make the ink compatible with high-speed printing (50 to 300 m/min) in the gravure printing method. More preferably, the stated viscosity is 50 to 400 cps. This viscosity range corresponds to the viscosity measured with Zahn cup #4 of approximately 9 seconds to 40 seconds. The viscosity of the solvent-type gravure ink for a laminate can be adjusted by selecting, as appropriate, the type and/or the amount of the source materials to be used, such as the amounts of the pigment (A), the polyurethane resin (b1), the vinyl chloride copolymer resin (b2) (preferably, a vinyl chloride copolymer resin (b2) having a hydroxyl group), the organic solvent (C), the water (D), and so on. In addition, the viscosity of the ink can also be adjusted by controlling the granularity and the granularity distribution of the pigment in the ink.

### <Printed Material>

The solvent-type gravure ink for a laminate according to the present invention can be used for printing in the gravure printing method. The solvent-type gravure ink for a laminate according to the present invention can, for example, be diluted with a diluent solvent to a viscosity and a density suitable for gravure printing as necessary, and one type of the gravure ink alone or a mixture of two or more types of the gravure ink can be supplied to a printing unit. A substrate is printed with the solvent-type gravure ink for a laminate according to the present invention, and a printed layer is formed by removing a volatile component. Thus, a printed material can be obtained.

### <Substrate>

Examples of the substrate that can be used in the printed material according to the present invention include a film-like substrate composed of polyolefin resin, such as polyethylene or polypropylene; polyester resin, such as polyethylene terephthalate or polylactic acid; polycarbonate resin; polystyrene resin, such as polystyrene, AS resin, or ABS resin; polyamide resin, such as nylon; polyvinyl chloride; polyvinylidene chloride; cellophane; paper; aluminum; or a composite material of the above. In addition, a deposition substrate in which an inorganic compound, such as silica, alumina, or aluminum, is deposited on a plastic film of polyethylene terephthalate, nylon, or the like can also be used. The surface that has been deposition-treated with an inorganic compound or the like may be subjected to surface treatment through coating treatment with polyvinyl alcohol or the like, corona treatment, or the like.

### <Layered Product>

A layered product according to the present invention includes at least an adhesive layer and a film layer provided in this order on a printed layer of the printed material. Preferable materials of the film layer include aluminum, nylon, and unstretched polyolefin. The layered product according to the present invention can be obtained through a well-known lamination process, and examples include an extrusion lamination method in which a molten polyethylene resin and a film are laminated in this order on a printed layer with various anchor coating agents, such as imine-based anchor coating agent, isocyanate-based anchor coating agent, polybutadiene-based anchor coating agent, or titanium-based anchor coating agent, interposed therebetween; a dry lamination method or a non-solvent lamination method in which a printed surface is coated with an adhesive, such as a urethane-based adhesive, and a plastic film is laminated thereon; and a direct lamination method in which molten polypropylene is press-bonded and laminated directly onto a printed surface.

### EXAMPLES

Hereinafter, the present invention will be described in detail through examples, but the present invention is not limited to these examples. It is to be noted that “part(s)” and “%” indicated in this section denote “part(s) by mass” and “mass %” unless particularly specified otherwise.

### (Hydroxyl Value)

The hydroxyl value is a value obtained by converting, into the mg number of potassium hydroxide, the amount of hydroxyl group in 1 g of the resin calculated by esterifying or acetylating the hydroxyl group in the resin with an excess of anhydrous acid and back titrating the remaining acid with an alkali. The hydroxyl value was measured in accordance with JIS K 0070 (year 1992).

### (Amine Value, Acid Value)

The amine value is the mg number of potassium hydroxide in an amount equivalent to the amount of hydrochloric acid necessary for neutralizing the amino group contained in 1 g of the resin. The acid value is the mg number of potassium hydroxide necessary for neutralizing the acid radical contained in 1 g of the resin.

The acid value was measured in accordance with JIS K 0070 (year 1992).

The amine value was measured in the following method in accordance with JIS K 0070 (year 1992).

### Method of Measuring Amine Value

A sample was precisely weighted to 0.5 to 2 g (sample amount: Sg). 30 mL of neutral ethanol (BDG neutral) was added to the precisely weighted sample and the sample was dissolved. The obtained solution was titrated with the use of a 0.2-mol/L ethanolic hydrochloric acid solution (titer: f). A point at which the color of the solution changed from green to yellow was set to the end point. The amine value was obtained through the following expression (4) with the use of the titration amount (AmL) at the end point.

amine value=(A×f×0.2×56.108)/S Expression (4):

### (Weight-Average Molecular Weight)

The weight-average molecular weight was obtained through GPC (gel permeation chromatography). The molecular-weight distribution was measured with the use of “Shodex GPC System-21” manufactured by Showa Denko K. K., and the polystyrene-equivalent molecular weight was obtained. The measuring condition is illustrated below.

Column: The following columns were coupled in series for use.

TSKgel Super AW2500 manufactured by Tosoh Corporation

TSKgel Super AW3000 manufactured by Tosoh Corporation

TSKgel Super AW4000 manufactured by Tosoh Corporation

TSKgel guard column Super AWH manufactured by Tosoh Corporation

Detector: RI (differential refractometer)
Measuring Condition: Column temperature of 40° C.

### Eluate: Dimethylformamide

Rate of Flow: 1.0 mL/min

### (Synthesis Example 1-1) [Polyurethane Resin PU1-1]

170 parts of polyester polyol (hereinafter “PMPA”) having a number-average molecular weight of 2000 obtained from adipic acid and 3-methyl-1,5-pentanediol, 20 parts of polypropylene glycol (hereinafter, “PPG”) having a number-average molecular weight of 2000, 10 parts of PPG having a number-average molecular weight of 1000, 53.7 parts of isophorone diisocyanate (hereinafter, “IPDI”), and 63.4 parts of ethyl acetate were allowed to react for four hours at 80° C. under a nitrogen stream, and a terminal isocyanate prepolymer solution was obtained. Then, the obtained terminal isocyanate prepolymer solution was gradually added at 40° C. to a mixed solution of 23.9 parts of isophorone diamine (hereinafter, “IPDA”), 2.0 parts of iminobispropylamine (hereinafter, “IBPA”), 1.0 part of 2-ethanolamine (hereinafter, “2EtAm”), and 591.3 parts of a 70/30-mixed solvent of ethyl acetate/isopropanol (hereinafter, “IPA”), and this was allowed to react for one hour at 80° C. In this manner, a polyurethane resin solution PU1-1 having a solid content of 30%, an amine value of 11.1 mgKOH/g, a hydroxyl value of 3.3 mgKOH/g, and a weight-average molecular weight of 38000 was obtained.

Primary synthesis conditions and the properties of the obtained polyurethane resin solution are shown in Table 1-1.

### (Synthesis Example 1-2) [Polyurethane Resin PU1-2]

A polyurethane resin solution PU1-2 was obtained through a method similar to that of Synthesis Example 1-1 except that the source materials shown in Table 1-1 were used. In Table 1-1, PPA, PEG, and TDI represent the following compounds.

PPA: polyester polyol that is a condensate of adipic acid and 1,2-propane diol (propylene glycol)
PEG: polyethylene glycol
TDI: tolylene diisocyanate (methyl-1,3-phenylene diisocyanate)

### (Synthesis Example 1-3) [Polyurethane Resin PU1-3]

A four-necked flask provided with a stirrer, a thermometer, a reflux condenser, and a nitrogen gas introducing tube was charged with 80 parts of neopentyl glycol adipate diol (hydroxyl value: 56.6 mgKOH/g), 20 parts of polyethylene glycol (hydroxyl value: 278 mgKOH/g), and 29.68 parts of isophorone diisocyanate, and this was allowed to react for 10 hours at 90° C. under a nitrogen stream to manufacture a urethane prepolymer having an isocyanate group content by percentage of 2.84 mass %. 69.8 parts of ethyl acetate was added to the above to obtain a uniform solution of the urethane prepolymer. Then, this urethane prepolymer solution was added to a mixture consisting of 7.97 parts of isophorone diamine, 0.11 parts of di-n-butylamine, 139.1 parts of ethyl acetate, and 112.5 parts of isopropyl alcohol, and this was allowed to react while being stirred for five hours at 45° C. to obtain a polyurethane resin solution PU1-3. The obtained polyurethane resin solution PU1-3 had a concentration of a solid resin content of 30.4%, an amine value of a solid resin content of 9.5 mgKOH/g, and a weight-average molecular weight of a solid resin content of 44,000. The content of a structural unit derived from a polyether was 14.5%.

### (Comparative Synthesis Examples 1-1 and 1-2) [Polyurethane Resins PU1-4 and PU1-5]

Polyurethane resin solutions PU1-4 and PU1-5 were obtained through a method similar to that of Synthesis Example 1-1 except that the source materials shown in Table 1-1 were used.

### (Comparative Synthesis Example 1-3) [Polyurethane Resin PU1-6]

A four-necked flask provided with a stirrer, a thermometer, a reflux condenser, and a nitrogen gas introducing tube was charged with 605.9 parts of polyester diol having a number-average molecular weight of 1,800 composed of a condensate of adipic acid and a mixture of ethylene glycol and neopentyl glycol (mole ratio=1/1) and 94 parts of isophorone diisocyanate, and this was allowed to react for 10 hours at 90° C. under a nitrogen stream. 300 parts of ethyl acetate was added to the above to obtain a uniform solution of a urethane prepolymer. Then, this urethane prepolymer solution was added to a mixture consisting of 18.1 parts of isophorone diamine, 873 parts of ethyl acetate, and 503 parts of IPA, and this was allowed to react while being stirred for eight hours at 45° C. to obtain a polyurethane resin solution PU1-6. The obtained polyurethane resin solution had a concentration of a solid resin content of 30%, an amine value of 5.3 mgKOH/g, and a weight-average molecular weight of 49,000. The content of a structural unit derived from a polyether was 0.0%.

### (Synthesis Example 2-1) [Polyurethane Resin PU2-1]

170 parts of polyester polyol (hereinafter “NPG/AA”) having a number-average molecular weight of 2000 obtained from adipic acid and neopentyl glycol, 30 parts of polyethylene glycol (hereinafter, “PEG”) having a number-average molecular weight of 1000, 58.8 parts of isophorone diisocyanate (hereinafter, “IPDI”), and 64.7 parts of ethyl acetate were allowed to react for four hours at 80° C. under a nitrogen stream, and a terminal isocyanate prepolymer solution was obtained. Then, the obtained terminal isocyanate prepolymer solution was gradually added at 40° C. to a mixed and stirred solution of 25.8 parts of isophorone diamine (hereinafter, “IPDA”), 2.0 parts of iminobispropylamine (hereinafter, “IBPA”), 1.5 parts of 2-ethanolamine (hereinafter, “2EtAm”), and 607.4 parts of a 70/30-mixed solvent of ethyl acetate/isopropanol (hereinafter, “IPA”), and this was allowed to react for one hour at 80° C. In this manner, a polyurethane resin solution PU2-1 having a solid content of 30%, an amine value of 11.1 mgKOH/g, a hydroxyl value of 4.8 mgKOH/g, and a weight-average molecular weight of 40000 was obtained.

Primary synthesis conditions and the properties of the obtained polyurethane resin solution are shown in Table 1-2.

### (Synthesis Example 2-2 and Reference Synthesis Example 2-3) [Polyurethane Resins PU2-2 and PU2-3]

Polyurethane resin solutions PU2-2 and PU2-3 were obtained through a method similar to that of Synthesis Example 2-1 except that the source materials shown in Table 1-2 were used. In Table 1-2, PMPA, PPG, and TDI represent the following compounds.

PMPA: polyester polyol that is a condensate of 3-methyl-1,5-pentanediol and adipic acid
PPG: polypropylene glycol
TDI: tolylene diisocyanate (methyl-1,3-phenylene diisocyanate)

### (Synthesis Example 3-1) [Vinyl Chloride-Acrylic Copolymer Resin PVAc1]

In a 1.0-L autoclave, a solution obtained by dissolving 1.0 g of potassium peroxodisulfate (K25208) in 500 g of ion-exchanged water was placed and degassed. After the temperature was raised to 60° C., 425 g of a mixture consisting of 357 g of vinyl chloride, 63 g of 2-hydroxypropyl acrylate, and 5.0 g of sodium di-2-ethylhexylsulfosuccinate (product name: Aerosol OT) was added, and this was allowed to react at 60° C. at 6.5 atm. The polymerization reaction was carried out until the pressure of the autoclave reached 2.5 atm. The generated emulsion was precipitated with the use of sodium chloride, filtered, washed, and dried to obtain a vinyl chloride-acrylic copolymer resin. This vinyl chloride-acrylic copolymer resin was further dissolved in ethyl acetate to obtain varnish (PVAc1) having a solid content of 30%. The obtained resin had a content by percentage of a 2-hydroxypropyl acrylate unit of 14%, a weight-average molecular weight of 50000, and a glass transition temperature of 70° C.

### (Glycol Ether-Based Solvent)

Table 2 shows a list of glycol ether-based solvents used in Examples and Comparative Examples. In Table 2, the catalog values are indicated for the boiling points, and the Hansen solubility parameter values in Polymer Handbook (Fourth Edition) are indicated for the SP values.

### (Example 1-1) [Fabrication of Solvent-Type Gravure Ink S1-1 For Laminate]

40 parts of the polyurethane resin solution PU1-1 (solid content: 30%), 5.0 parts of a vinyl chloride-vinyl acetate copolymer resin solution (SOLBIN TAO manufactured by Nissin Chemical Industry Co., Ltd., vinyl chloride:vinyl acetate:vinylalcohol (mass ratio)=91:2:7, ethyl acetate solution having a solid content of 30%), 10 parts of C.I. Pigment Red 57:1 (azo lake red pigment), and 37 parts of a 70/30-solution of n-propyl acetate/IPA were mixed and dispersed for 30 minutes with an eiger mill. Thereafter, 5.0 parts of ethylene glycol monomethyl ether and 3.0 parts of water were added and mixed to the above while being stirred with a disperser, and a solvent-type gravure ink S1-1 for a laminate was obtained. The mixing composition is shown in Table 3-1.

### (Examples 1-2 to 1-22) [Fabrication of Solvent-Type Gravure Inks S1-2 to S1-22 for Laminate]

Solvent-type gravure inks S1-2 to S1-22 for a laminate were obtained through a method similar to that of Example 1-1 except that the source materials shown in Table 3-1 and Table 3-2 were used.

With regard to the pigments shown in Table 3-1 and Table 3-2, C.I. Pigment Blue 15:3 is a phthalocyanine indigo pigment, and C.I. Pigment Black 7 is a carbon black pigment.

### (Comparative Examples 1-1 to 1-13) [Fabrication of Solvent-Type Gravure Inks T1-1 to T1-13 for Laminate]

Solvent-type gravure inks T1-1 to T1-13 for a laminate were obtained through a method similar to that of Example 1-1 except that the source materials shown in Table 4 were used.

### (Example 1-23) [Manufacture of Printed Material and Layered Product]

The solvent-type gravure ink S1-1 (indigo ink) for a laminate obtained in the above-described example was diluted to have a viscosity of 16 seconds (25° C., Zahn cup No. 3) with the use of a mixed solvent (methyl ethyl ketone “MEK”:n-propyl acetate “NPAC”:isopropanol “IPA” (mass ratio)=40:40:20). With the use of a Helio 175-line gradation plate (plate compressed, 100% to 3% gradation pattern), a corona-discharge-treated surface of a corona-discharge-treated polyester (PET) film (E-5100 manufactured by Toyobo Co., Ltd.) having a thickness of 12 μm was printed with the obtained diluted ink at a printing rate of 150 m/min, and a printed material G1-1 was obtained. The printing was carried out for the printing distance of 4000 m under a high-temperature, high-humidity environment of a temperature of 32° C. and a humidity of 80%. The plate was idled for 60 minutes after the printing was finished, and the fogging property was evaluated.

The obtained printed material G1-1 was coated with an ethyl acetate solution of a polyether urethane-based lamination adhesive (TM320/CAT13B manufactured by Toyo-Morton, Ltd.) at a solid content of 25% to have a dry coating amount of 1.5 g/m² and was dried. Aluminum-deposited unstretched polypropylene (VMCP 2203, film thickness of 25 μm, manufactured by Toray Advanced Film Co., Ltd.) was affixed to the above through a dry lamination process to obtain a layered product (laminated product).

The obtained solvent-type gravure inks for a laminate, the printed materials, and the layered products were evaluated as described later. The evaluation results are shown in Table 5-1. The layered products were evaluated after the layered products were retained for 48 hours at 50° C.

### Examples 1-24 to 1-44

Printed materials G1-2 to G1-22 and layered products (laminated products) were obtained through a method similar to that of Example 1-23 except that the solvent-type gravure inks S1-2 to S1-22 for a laminate were used, and the evaluation was carried out. The evaluation results are shown in Table 5-1.

### Comparative Examples 1-14 to 1-26

Printed materials H1-1 to H1-13 and layered products (laminated products) were obtained through a method similar to that of Example 1-23 except that the solvent-type gravure inks T1-1 to T1-13 for a laminate were used, and the evaluation was carried out. The evaluation results are shown in Table 5-2.

### (Example 2-1) [Fabrication of Solvent-Type Gravure Ink S2-1 for Laminate]

30 parts of the polyurethane resin solution PU2-1 (solid content: 30%), 5.0 parts of a vinyl chloride-vinyl acetate copolymer resin solution (SOLBIN TAO manufactured by Nissin Chemical Industry Co., Ltd., vinyl chloride:vinyl acetate:vinylalcohol (mass ratio)=91:2:7, ethyl acetate solution having a solid content of 30%), 30 parts of titanium oxide (JR-806 manufactured by Tayca Corporation, rutile-type crystal structure, surface-treated with silica and alumina, mean particle size of 0.27 μm, amount of oil absorption of 21 (ml/100 g)), and 29 parts of a mixed solution of n-propyl acetate/IPA (mass ratio)=70/30 were mixed and dispersed for 20 minutes with an eiger mill. Thereafter, 3.0 parts of ethylene glycol monomethyl ether and 3.0 parts of water were added and mixed to the above while being stirred with a disperser, and a solvent-type gravure ink S2-1 for a laminate was obtained. The mixing composition is shown in Table 6-1.

### (Examples 2-2 to 2-10, Reference Example 2-11, Examples 2-12 to 2-22) [Fabrication of Solvent-Type Gravure Inks S2-2 to S2-22 for Laminate]

Solvent-type gravure inks S2-2 to S2-22 for a laminate were obtained through a method similar to that of Example 2-1 except that the source materials shown in Table 6-1 and Table 6-2 were used. In Table 6-1 and Table 6-2, CR-57, CR-85, and JA-3 represent the following respective titanium oxides.

CR-57: manufactured by Ishihara Sangyo Kaisha, Ltd., titanium oxide, rutile-type crystal structure, surface-treated with alumina, zirconia, and organic matter, mean particle size of 0.25 μm, amount of oil absorption of 17 (ml/100 g)
CR-85: manufactured by Ishihara Sangyo Kaisha, Ltd., titanium oxide, rutile-type crystal structure, surface-treated with silica and alumina, mean particle size of 0.25 μm, amount of oil absorption of 30 (ml/100 g)
JA-3: manufactured by Tayca Corporation, titanium oxide, anatase-type crystal structure, no surface treatment, mean particle size of 0.18 μm, amount of oil absorption of 23 (ml/100 g)

### (Comparative Examples 2-1 to 2-9) [Fabrication of Solvent-Type Gravure Inks T2-1 to T2-9 for Laminate]

Solvent-type gravure inks T2-1 to T2-9 for a laminate were obtained through a method similar to that of Example 2-1 except that the source materials shown in Table 7 were used.

### (Examples 2-23 to 2-32, Reference Example 2-33, Examples 2-34 to 2-44) [Manufacture of Printed Material and Layered Product]

Printed materials G2-2 to G2-22 and layered products (laminated products) were obtained through a method similar to that of Example 1-23 except that the solvent-type gravure inks S2-1 to S2-22 for a laminate were used, and the evaluation was carried out. The evaluation results are shown in Table 8-1.

### Comparative Examples 2-10 to 2-18

Printed materials H2-1 to H2-9 and layered products (laminated products) were obtained through a method similar to that of Example 1-23 except that the solvent-type gravure inks T2-1 to T2-9 for a laminate were used, and the evaluation was carried out. The evaluation results are shown in Table 8-2.

### (Evaluation Item And Evaluation Method)

### <Ink Stability 1>

The ink stability 1 of the solvent-type gravure inks S1-1 to S1-22 (Examples) and T1-1 to T1-13 (Comparative Examples) for a laminate was evaluated. The inks were stored for 10 days at 50° C. The viscosity was measured before storage and after storage, and a change in the viscosity held after storage relative to that held before storage was evaluated. The viscosity was measured in the number of seconds in which the ink flowed out of Zahn cup No. 4 at 25° C.

5 . . . The change in the viscosity is less than 2 seconds.
4 . . . The difference in the viscosity is no less than 2 seconds and less than 5 seconds.
3 . . . The difference in the viscosity is no less than 5 seconds and less than 10 seconds.
2 . . . The difference in the viscosity is no less than 10 seconds and less than 15 seconds.
1 . . . The difference in the viscosity is no less than 15 seconds.

The rating of 5 or 4 corresponds to a range where there is no problem in practical use.

### <Ink Stability 2>

The ink stability 2 of the solvent-type gravure inks S2-1 to S2-22 (Examples and Reference Example) and T2-1 to T2-9 (Comparative Examples) for a laminate was evaluated. The inks were stored for 14 days at 40° C. The viscosity was measured before storage and after storage, and a change in the viscosity held after storage relative to that held before storage was evaluated. The viscosity was measured in the number of seconds in which the ink flowed out of Zahn cup No. 4 at 25° C.

5 . . . The change in the viscosity is less than 3 seconds.
4 . . . The difference in the viscosity is no less than 3 seconds and less than 6 seconds.
3 . . . The difference in the viscosity is no less than 6 seconds and less than 10 seconds.
2 . . . The difference in the viscosity is no less than 10 seconds and less than 15 seconds.
1 . . . The difference in the viscosity is no less than 15 seconds.

The rating of 5 or 4 corresponds to a range where there is no problem in practical use.

### <Whitening (Color Change)>

Whitening (color change) of the printed materials G1-1 to G1-22 and G2-1 to G2-22 (Examples) and H1-1 to H1-13 and H2-1 to H2-9 (Comparative Examples) was evaluated. The whitened state (color change) of these printed materials was evaluated by observing the condition of the printed materials after the printed materials were stored for seven days in an oven at 40° C. with a humidity of 90%. “Whitening” refers to a color change in which the appearance of the printed surface loses a gloss and becomes opaque (blurred).

5 . . . There is no color change (no whitening).
4 . . . A portion with a color change (whitened portion) on the printed surface is less than 5%.
3 . . . A portion with a color change (whitened portion) on the printed surface is no less than 5% and less than 20%.
2 . . . A portion with a color change (whitened portion) on the printed surface is no less than 20% and less than 50%.
1 . . . The entire surface is whitened.

The rating of 5 or 4 corresponds to a range where there is no problem in practical use.

### <Filming Property>

The filming property of the solvent-type gravure inks S1-1 to S1-22 and S2-1 to S2-22 (Examples and Reference Example) and T1-1 to T1-13 and T2-1 to T2-9 (Comparative Examples) for a laminate was evaluated. 500 parts of each ink was diluted to have a viscosity of 16 seconds (25° C., Zahn cup No. 3) with the use of a mixed solvent (methyl ethyl ketone “MEK”:n-propyl acetate “NPAC”:isopropanol “IPA” (mass ratio)=40:40:20). This was placed in a receptacle and stored for 30 minutes in an oven at 40° C. in a state in which the top of the receptacle was open. Thereafter, the filming condition was evaluated.

5 . . . No filming is observed in the ink surface.
4 . . . Filming is observed in the ink surface at less than 5%.
3 . . . Filming is observed in the ink surface at no less than 5% and less than 20%.
2 . . . Filming is observed in the ink surface at no less than 20% and less than 50%.
1 . . . Filming is observed in the entire surface.

The rating of 5 or 4 corresponds to a range where there is no problem in practical use.

### <Doctor Blade Wear Property>

The doctor blade wear property of the solvent-type gravure inks S1-1 to S1-22 and S2-1 to S2-22 (Examples and Reference Example) and T1-1 to T1-13 and T2-1 to T2-9 (Comparative Examples) for a laminate was evaluated. Each ink was diluted to have a viscosity of 16 seconds (25° C., Zahn cup No. 3) with the use of a mixed solvent (methyl ethyl ketone “MEK”:n-propyl acetate “NPAC”:isopropanol “IPA” (mass ratio)=40:40:20). In a state in which the plate is not printing, the plate was idled for 180 minutes at a printing rate of 200 m/min and at a doctor blade pressure of 3.0 kgf/cm². Thereafter, the length of the blade edge of the doctor blade was measured with the use of a microphone VH manufactured by Keyence Corporation, and its difference from the length of the blade edge of an unused doctor blade was obtained as a doctor blade wear amount (μm). For the doctor blade, one with the product name of “New Doctor Hi-Blade” (manufactured by Fuji Shoko Co., Ltd.) with a blade edge thickness of 65 μm was used.

6 . . . The wear amount is less than 30 μm.
5 . . . The wear amount is no less than 30 μm and less than 50 μm.
4 . . . The wear amount is no less than 50 μm and less than 80 μm.
3 . . . The wear amount is no less than 80 μm and less than 120 μm.
2 . . . The wear amount is no less than 120 μm and less than 150 μm.
1 . . . The wear amount is no less than 150 μm.

The rating of 6, 5, or 4 corresponds to a range where there is no problem in practical use.

### <Fogging Property>

The fogging property of the solvent-type gravure inks S1-1 to S1-22 and S2-1 to S2-22 (Examples and Reference Example) and T1-1 to T1-13 and T2-1 to T2-9 (Comparative Examples) for a laminate was evaluated. The evaluation was carried out on the basis of the colored area on the plate after the plate was idled for 60 minutes.

6 . . . No fogging is observed.
5 . . . The area with fogging is more than 0% and less than 5%.
4 . . . The area with fogging is no less than 5% and less than 10%.
3 . . . The area with fogging is no less than 10% and less than 30%.
2 . . . The area with fogging is no less than 30% and less than 50%.
1 . . . The area with fogging is no less than 50%.

The rating of 6, 5, or 4 corresponds to a range where there is no problem in practical use.

### <Lamination Strength>

The lamination strength of dry-laminated products of the obtained printed materials G1-1 to G1-22 and G2-1 to G2-22 (Examples and Reference Example) and H1-1 to H1-13 and H2-1 to H2-9 (Comparative Examples) was evaluated. The printed portion was cut at a width of 15 mm, and the ink surface and the substrate surface were peeled off each other. The peeling strength (lamination strength) at this point was measured with the use of a 201 universal tension tester manufactured by Intesco Co., Ltd. The practical level is 0.7 N/15 mm or greater.

5 . . . The lamination strength is no less than 1.0 N/15 mm.
4 . . . The lamination strength is no less than 0.7 N/15 mm and less than 1.0 N/15 mm.
3 . . . The lamination strength is no less than 0.5 N/15 mm and less than 0.7 N/15 mm.
2 . . . The lamination strength is no less than 0.3 N/15 mm and less than 0.5 N/15 mm.
1 . . . The lamination strength is less than 0.3 N/15 mm.

The rating of 5 or 4 corresponds to a range where there is no problem in practical use.

TABLE 1-1

| | | | | | Comparative | Comparative |
|---|---|---|---|---|---|---|
| | | | Synthesis | Synthesis | Synthesis | Synthesis |
| | | Molecular | Example 1-1 | Example 1-2 | Example 1-1 | Example 1-2 |
| Type | Material | Weight | PU1-1 | PU1-2 | PU1-4 | PU1-5 |
| Polyol | PMPA | 2000 | 170 | | | 200 |
| | | 1000 | | | | |
| | PPA | 2000 | | 100 | | |
| | PEG | 2000 | | 10 | | |
| | PPG | 2000 | 20 | 90 | 200 | |
| | | 1000 | 10 | | | |
| Solvent | Ethyl Acetate | | 63.4 | 60.9 | 61.1 | 61.1 |
| Isocyanate | TDI | 174.2 | 0.0 | 19.2 | 0.0 | 0.0 |
| | IPDI | 222.29 | 53.7 | 24.5 | 44.5 | 44.5 |
| Amine | IPDA | 170.3 | 23.9 | 20.9 | 17.7 | 18.1 |
| | IBPA | 60.1 | 2.0 | 0.0 | 0.0 | 0.0 |
| | 2EtAm | 61.08 | 1.0 | 1.0 | 1.0 | 1.0 |

| Solvent | Ethyl Acetate/IPA | 591.3 | 558.7 | 553.0 | 553.8 |
|---|---|---|---|---|---|
| Structural Unit Derived from Polyether % | | 11 | 38 | 76 | 0 |
| Structural Unit Derived from Polyester % | | 61 | 38 | 0 | 76 |
| Total Solid Content | | 280.6 | 265.5 | 263.2 | 263.5 |
| Composition Ratio | NCO/OH | 2.3 | 2.2 | 2.0 | 2.0 |
| | NH/Remaining NCO | 1.04 | 1.04 | 1.05 | 1.06 |
| Properties | Solid Content % | 30 | 30 | 30 | 30 |
| | Hydroxyl Value (mgKOH/g) | 3.3 | 3.5 | 3.5 | 3.5 |
| | Amine Value (mgKOH/g) | 11.1 | 9.0 | 7.5 | 4.1 |
| | Weight-Average Molecular Weight | 38000 | 38000 | 33000 | 30000 |

TABLE 1-2

| | | | | | Reference |
|---|---|---|---|---|---|
| | | | Synthesis Example 2-1 | Synthesis Example 2-2 | Synthesis Example |
| Type | Material | Molecular Weight | PU2-1 | PU2-2 | PU2-3 |
| Polyol | NPG/AA | 2000 | 170 | | 200 |
| | | 1000 | | | |
| | PMPA | 2000 | | 120 | |
| | PEG | 1000 | 30 | | |
| | PPG | 2000 | | 40 | |
| | | 1000 | | 40 | |
| Solvent | Ethyl Acetate | | 64.7 | 64.7 | 60.6 |
| Isocyanate | TDI | 174.2 | 0.0 | 0.0 | 7.0 |
| | IPDI | 222.29 | 58.8 | 58.7 | 35.6 |
| Amine | IPDA | 170.3 | 25.8 | 25.3 | 15.6 |
| | IBPA | 60.1 | 2.0 | 0.0 | 0.0 |
| | 2EtAm | 61.08 | 1.5 | 1.0 | 3.5 |

| Solvent | Ethyl Acetate/IPA | 607.4 | 600.3 | 549.8 |
|---|---|---|---|---|
| Structural Unit Derived from Polyether % | | 10 | 28 | 0 |
| Structural Unit Derived from Polyester % | | 59 | 42 | 76 |
| Total Solid Content | | 288.1 | 285.0 | 261.6 |
| Composition Ratio | NCO/OH | 2.3 | 2.2 | 2.0 |
| | NH/Remaining NCO | 1.04 | 1.04 | 1.06 |
| Properties | Solid Content % | 30 | 30 | 30 |
| | Hydroxyl Value (mgKOH/g) | 4.8 | 3.2 | 12.3 |
| | Amine Value (mgKOH/g) | 11.1 | 9.0 | 4.1 |
| | Weight-Average | 40000 | 38000 | 35000 |
| | Molecular Weight | | | |

TABLE 2

| | | Boiling | Surface |
|---|---|---|---|
| | SP Value | Point | Tension |
| Glycol Ether-Based Solvent (c1) | (cal/cm³)^{1/2} | (° C.) | (mN/m) |
| Ethylene Glycol Monomethyl Ether | 11.6 | 124 | 26.6 |
| Propylene Glycol Monomethyl Ether | 10.4 | 121 | 23.5 |
| Ethylene Glycol Monoisopropyl Ether | 9.2 | 142 | 22.9 |
| Propylene Glycol Mono-n-propyl Ether | 9.4 | 150 | 22.8 |
| Diethylene Glycol Monoisobutyl Ether | 8.7 | 220 | 24.6 |
| Triethylene Glycol Monomethyl Ether | 10.5 | 249 | 31.9 |

*All manufactured by Nippon Nyukazai Co., Ltd.

TABLE 3-1

| | | | | Examples | | | | | | | | | | |
|---|---|---|---|---|---|---|---|---|---|---|---|---|---|---|
| | | | | 1-1 | 1-2 | 1-3 | 1-4 | 1-5 | 1-6 | 1-7 | 1-8 | 1-9 | 1-10 | 1-11 |
| Ink | | | | S1-1 | S1-2 | S1-3 | S1-4 | S1-5 | S1-6 | S1-7 | S1-8 | S1-9 | S1-10 | S1-11 |
| Mixing | Binder | Polyurethane | PU1-1 | 40 | 40 | 40 | 40 | 40 | 40 | 40 | 40 | 40 | | 40 |
| Composition | Resin (B) | Resin (b1) | PU1-2 | | | | | | | | | | 40 | |
| | Solution | | PU1-3 | | | | | | | | | | | |
| | | Vinyl Chloride | Vinyl Chloride-Vinyl | 5 | 5 | 5 | 5 | 5 | 5 | 5 | 5 | 5 | 5 | 5 |
| | | Copolymer | Acetate Copolymer | | | | | | | | | | | |
| | | Resin (b2) | Resin | | | | | | | | | | | |
| | | | Vinyl Chloride-Acrylic | | | | | | | | | | | |
| | | | Copolymer Resin PVAc1 | | | | | | | | | | | |

| Pigment (A) | C.I. Pigment Blue 15:3 | | | | | | | | | | | |
|---|---|---|---|---|---|---|---|---|---|---|---|---|
| | C.I. Pigment Black 7 | | | | | | | | | | | |
| | C.I. Pigment Red 57:1 | 10 | 10 | 10 | 10 | 10 | 10 | 10 | 10 | 10 | 10 | 10 |
| Organic Solvent (C) | n-Propyl Acetate/ | 37.0 | 37.0 | 37.0 | 37.0 | 37.0 | 37.0 | 41.8 | 32.0 | 30.0 | 37.0 | 39.8 |
| | IPA = 70/30 | | | | | | | | | | | |

| | | | | | | | | | | | | |
|---|---|---|---|---|---|---|---|---|---|---|---|---|
| | 1-Propanol | | | | | | | | | | | |
| Glycol Ether- | Ethylene Glycol | 5 | | | | | | | | | | |
| Based Organic | Monomethyl Ether | | | | | | | | | | | |
| Solvent (c1) | Propylene Glycol | | 5 | | | | | 0.2 | 10 | 12 | 5 | 5 |
| | Monomethyl Ether | | | | | | | | | | | |
| | Ethylene Glycol | | | 5 | | | | | | | | |
| | Monoisopropyl Ether | | | | | | | | | | | |
| | Propylene Glycol | | | | 5 | | | | | | | |
| | Mono-n-propyl Ether | | | | | | | | | | | |
| | Diethylene Glycol | | | | | 5 | | | | | | |
| | Monoisobutyl Ether | | | | | | | | | | | |
| | Triethylene Glycol | | | | | | 5 | | | | | |
| | Monomethyl Ether | | | | | | | | | | | |

| | | | | | | | | | | | |
|---|---|---|---|---|---|---|---|---|---|---|---|
| Water (D) | 3 | 3 | 3 | 3 | 3 | 3 | 3 | 3 | 3 | 3 | 0.2 |
| Total (%) | 100 | 100 | 100 | 100 | 100 | 100 | 100 | 100 | 100 | 100 | 100 |

| | | | | | | | | | | | | |
|---|---|---|---|---|---|---|---|---|---|---|---|---|
| Resin Composition | (b1)/((b1) + (b2))% | 88.9 | 88.9 | 88.9 | 88.9 | 88.9 | 88.9 | 88.9 | 88.9 | 88.9 | 88.9 | 88.9 |
| (Solid Content Ratio) | (b2)/((b1) + (b2))% | 11.1 | 11.1 | 11.1 | 11.1 | 11.1 | 11.1 | 11.1 | 11.1 | 11.1 | 11.1 | 11.1 |

TABLE 3-2

| | | | | Examples | | | | | | | | | | |
|---|---|---|---|---|---|---|---|---|---|---|---|---|---|---|
| | | | | 1-12 | 1-13 | 1-14 | 1-15 | 1-16 | 1-17 | 1-18 | 1-19 | 1-20 | 1-21 | 1-22 |
| Ink | | | | S1-12 | S1-13 | S1-14 | S1-15 | S1-16 | S1-17 | S1-18 | S1-19 | S1-20 | S1-21 | S1-22 |
| Mixing | Binder | Polyurethane | PU1-1 | 40 | 40 | 42 | 30 | 20 | 40 | 40 | 40 | 40 | | |
| Composition | Resin (B) | Resin (b1) | PU1-2 | | | | | | | | | | | |
| | Solution | | PU1-3 | | | | | | | | | | 40 | 40 |
| | | Vinyl Chloride | Vinyl Chloride-Vinyl | 5 | 5 | 3 | 15 | 25 | 2.5 | 5 | 5 | 5 | 5 | 5 |
| | | Copolymer | Acetate Copolymer | | | | | | | | | | | |
| | | Resin (b2) | Resin SOLBIN TAO | | | | | | | | | | | |
| | | | Vinyl Chloride-Acrylic | | | | | | 2.5 | | | | | |
| | | | Copolymer Resin PVAc1 | | | | | | | | | | | |

| Pigment (A) | C.I. Pigment Blue 15:3 | | | | | | | | | 10 | | |
|---|---|---|---|---|---|---|---|---|---|---|---|---|
| | C.I. Pigment Black 7 | | | | | | | | 10 | | | |
| | C.I. Pigment Red 57:1 | 10 | 10 | 10 | 10 | 10 | 10 | 10 | | | 10 | 10 |
| Organic Solvent (C) | n-Propyl Acetate/ | 39.0 | 35.5 | 37.0 | 37.0 | 37.0 | 37.0 | 37.0 | 37.0 | 37.0 | 37.0 | 32.0 |
| | IPA = 70/30 | | | | | | | | | | | |

| | | | | | | | | | | | | |
|---|---|---|---|---|---|---|---|---|---|---|---|---|
| | 1-Propanol | | | | | | | | | | | 5 |
| Glycol Ether- | Ethylene Glycol | | | | | | | | | | | |
| Based Organic | Monomethyl Ether | | | | | | | | | | | |
| Solvent (c1) | Propylene Glycol | 5 | 5 | 5 | 5 | 5 | 2.5 | 2.5 | 2.5 | 2.5 | 2.5 | 5 |
| | Monomethyl Ether | | | | | | | | | | | |
| | Ethylene Glycol | | | | | | 2.5 | 2.5 | 2.5 | 2.5 | 2.5 | |
| | Monoisopropyl Ether | | | | | | | | | | | |
| | Propylene Glycol | | | | | | | | | | | |
| | Mono-n-propyl Ether | | | | | | | | | | | |
| | Diethylene Glycol | | | | | | | | | | | |
| | Monoisobutyl Ether | | | | | | | | | | | |
| | Triethylene Glycol | | | | | | | | | | | |
| | Monomethyl Ether | | | | | | | | | | | |

| | | | | | | | | | | | |
|---|---|---|---|---|---|---|---|---|---|---|---|
| Water (D) | 1 | 4.5 | 3 | 3 | 3 | 3 | 3 | 3 | 3 | 3 | 3 |
| Total (%) | 100 | 100 | 100 | 100 | 100 | 100 | 100 | 100 | 100 | 100 | 100 |

| | | | | | | | | | | | | |
|---|---|---|---|---|---|---|---|---|---|---|---|---|
| Resin Composition | (b1)/((b1) + (b2))% | 88.9 | 88.9 | 93.3 | 66.7 | 44.4 | 88.9 | 88.9 | 88.9 | 88.9 | 88.9 | 88.9 |
| (Solid Content Ratio) | (b2)/((b1) + (b2))% | 11.1 | 11.1 | 6.7 | 33.3 | 55.6 | 11.1 | 11.1 | 11.1 | 11.1 | 11.1 | 11.1 |

TABLE 4

| | | | | Comparative Examples | | | | | | | |
|---|---|---|---|---|---|---|---|---|---|---|---|
| | | | | 1-1 | 1-2 | 1-3 | 1-4 | 1-5 | 1-6 | 1-7 | 1-8 |
| Ink | | | | T1-1 | T1-2 | T1-3 | T1-4 | T1-5 | T1-6 | T1-7 | T1-8 |
| Mixing | Binder | Polyurethane | PU1-1 | 45 | 44 | 15 | 40 | 40 | 40 | 40 | 40 |
| Composition | Resin (B) | Resin (b1) | | | | | | | | | |
| | Solution | Polyurethane | PU1-4 | | | | | | | | |
| | | Resin | PU1-5 | | | | | | | | |
| | | | PU1-6 | | | | | | | | |
| | | Vinyl Chloride | Vinyl Chloride-Vinyl | 0 | 1 | 30 | 5 | 5 | 5 | 5 | 5 |
| | | Copolymer | Acetate Copolymer | | | | | | | | |
| | | Resin (b2) | Resin SOLBIN TAO | | | | | | | | |

| Pigment (A) | C.I. Pigment Blue 15:3 | | | | | | | | |
|---|---|---|---|---|---|---|---|---|---|
| | C.I. Pigment Black 7 | | | | | | | | |
| | C.I. Pigment Red 57:1 | 10 | 10 | 10 | 10 | 10 | 10 | 10 | 10 |
| Organic Solvent (C) | n-Propyl Acetate/ | 37 | 37 | 37 | 40 | 42 | 45 | 17 | 30 |
| | IPA = 70/30 | | | | | | | | |

| | | | | | | | | | |
|---|---|---|---|---|---|---|---|---|---|
| Glycol Ether- | Ethylene Glycol | 5 | 5 | 5 | 5 | 0 | 0 | 25 | 5 |
| Based Organic | Monomethyl Ether | | | | | | | | |
| Solvent (c1) | | | | | | | | | |

| | | | | | | | | |
|---|---|---|---|---|---|---|---|---|
| Water (D) | 3 | 3 | 3 | 0 | 3 | 0 | 3 | 10 |
| Total (%) | 100 | 100 | 100 | 100 | 100 | 100 | 100 | 100 |

| | | | | | | | | | |
|---|---|---|---|---|---|---|---|---|---|
| Resin Composition | (b1)/(b1) + (b2)% | 100.0 | 97.8 | 33.3 | 88.9 | 88.9 | 88.9 | 88.9 | 88.9 |
| (Solid Content Ratio) | (b2)/(b1) + (b2)% | 0.0 | 2.2 | 66.7 | 11.1 | 11.1 | 11.1 | 11.1 | 11.1 |

| | | | | Comparative Examples | | | | |
|---|---|---|---|---|---|---|---|---|
| | | | | 1-9 | 1-10 | 1-11 | 1-12 | 1-13 |
| Ink | | | | T1-9 | T1-10 | T1-11 | T1-12 | T1-13 |
| Mixing | Binder | Polyurethane | PU1-1 | | | | 45 | 45 |
| Composition | Resin (B) | Resin (b1) | | | | | | |
| | Solution | Polyurethane | PU1-4 | 40 | | | | |
| | | Resin | PU1-5 | | 40 | | | |
| | | | PU1-6 | | | 40 | | |
| | | Vinyl Chloride | Vinyl Chloride-Vinyl | 5 | 5 | 5 | | |
| | | Copolymer | Acetate Copolymer | | | | | |
| | | Resin (b2) | Resin SOLBIN TAO | | | | | |

| Pigment (A) | C.I. Pigment Blue 15:3 | | | | | 10 |
|---|---|---|---|---|---|---|
| | C.I. Pigment Black 7 | | | | 10 | |
| | C.I. Pigment Red 57:1 | 10 | 10 | 10 | | |
| Organic Solvent (C) | n-Propyl Acetate/ | 37 | 37 | 37 | 37 | 37 |
| | IPA = 70/30 | | | | | |

| | | | | | | |
|---|---|---|---|---|---|---|
| Glycol Ether- | Ethylene Glycol | 5 | 5 | 5 | 5 | 5 |
| Based Organic | Monomethyl Ether | | | | | |
| Solvent (c1) | | | | | | |

| | | | | | |
|---|---|---|---|---|---|
| Water (D) | 3 | 3 | 3 | 3 | 3 |
| Total (%) | 100 | 100 | 100 | 100 | 100 |

| | | | | | | |
|---|---|---|---|---|---|---|
| Resin Composition | (b1)/(b1) + (b2)% | 88.9 | 88.9 | 88.9 | 100.0 | 100.0 |
| (Solid Content Ratio) | (b2)/(b1) + (b2)% | 11.1 | 11.1 | 11.1 | 0.0 | 0.0 |

TABLE 5-1

| | | Examples | | | | | | | | | | |
|---|---|---|---|---|---|---|---|---|---|---|---|---|
| | | 1-23 | 1-24 | 1-25 | 1-26 | 1-27 | 1-28 | 1-29 | 1-30 | 1-31 | 1-32 | 1-33 |
| Printing | Ink Name | S1-1 | S1-2 | S1-3 | S1-4 | S1-5 | S1-6 | S1-7 | S1-8 | S1-9 | S1-10 | S1-11 |
| Performance | Ink Stability 1 | 5 | 5 | 5 | 5 | 5 | 5 | 5 | 5 | 5 | 5 | 4 |
| | (50° C., 10 days) | | | | | | | | | | | |
| | Whitening | 5 | 5 | 5 | 5 | 5 | 5 | 5 | 5 | 5 | 5 | 5 |
| | Filming Property | 5 | 5 | 5 | 5 | 5 | 5 | 4 | 5 | 5 | 5 | 5 |
| | Doctor Blade Wear Property | 5 | 5 | 5 | 5 | 5 | 5 | 5 | 5 | 5 | 5 | 5 |
| | Fogging Property | 5 | 5 | 5 | 5 | 4 | 4 | 5 | 5 | 4 | 5 | 5 |
| Lamination | Printed Material | G1-1 | G1-2 | G1-3 | G1-4 | G1-5 | G1-6 | G1-7 | G1-8 | G1-9 | G1-10 | G1-11 |
| Suitability | Lamination Strength | 5 | 5 | 5 | 5 | 5 | 5 | 5 | 5 | 5 | 5 | 5 |

| | | Examples | | | | | | | | | | |
|---|---|---|---|---|---|---|---|---|---|---|---|---|
| | | 1-34 | 1-35 | 1-36 | 1-37 | 1-38 | 1-39 | 1-40 | 1-41 | 1-42 | 1-43 | 1-44 |
| Printing | Ink Name | S1-12 | S1-13 | S1-14 | S1-15 | S1-16 | S1-17 | S1-18 | S1-19 | S1-20 | S1-21 | S1-22 |
| Performance | Ink Stability 1 | 5 | 5 | 5 | 5 | 5 | 5 | 5 | 5 | 5 | 5 | 5 |
| | (50° C., 10 days) | | | | | | | | | | | |
| | Whitening | 5 | 5 | 5 | 5 | 5 | 5 | 5 | 5 | 5 | 5 | 5 |
| | Filming Property | 5 | 5 | 5 | 5 | 5 | 5 | 5 | 5 | 5 | 5 | 5 |
| | Doctor Blade Wear Property | 5 | 5 | 4 | 5 | 5 | 6 | 6 | 6 | 6 | 6 | 6 |
| | Fogging Property | 5 | 4 | 5 | 5 | 5 | 5 | 5 | 5 | 6 | 5 | 6 |
| Lamination | Printed Material | G1-12 | G1-13 | G1-14 | G1-15 | G1-16 | G1-17 | G1-18 | G1-19 | G1-20 | G1-21 | G1-22 |
| Suitability | Lamination Strength | 5 | 5 | 5 | 5 | 4 | 5 | 5 | 5 | 5 | 5 | 5 |

TABLE 5-2

| | | Comparative Examples | | | | | | | | | | | | |
|---|---|---|---|---|---|---|---|---|---|---|---|---|---|---|
| | | 1-14 | 1-15 | 1-16 | 1-17 | 1-18 | 1-19 | 1-20 | 1-21 | 1-22 | 1-23 | 1-24 | 1-25 | 1-26 |
| Printing | Ink Name | T1-1 | T1-2 | T1-3 | T1-4 | T1-5 | T1-6 | T1-7 | T1-8 | T1-9 | T1-10 | T1-11 | T1-12 | T1-13 |
| Performance | Ink Stability 1 | 3 | 4 | 5 | 2 | 3 | 2 | 3 | 3 | 3 | 3 | 3 | 5 | 5 |
| | (50° C., 10 days) | | | | | | | | | | | | | |
| | Whitening | 5 | 5 | 5 | 3 | 2 | 2 | 5 | 2 | 5 | 5 | 5 | 5 | 5 |
| | Filming Property | 3 | 3 | 4 | 4 | 3 | 2 | 5 | 2 | 5 | 3 | 3 | 3 | 3 |
| | Doctor Blade Wear Property | 3 | 3 | 4 | 4 | 3 | 2 | 5 | 3 | 5 | 2 | 2 | 4 | 4 |
| | Fogging Property | 3 | 4 | 3 | 4 | 4 | 3 | 1 | 3 | 3 | 4 | 4 | 3 | 3 |
| Lamination | Printed Material | H1-1 | H1-2 | H1-3 | H1-4 | H1-5 | H1-6 | H1-7 | H1-8 | H1-9 | H1-10 | H1-11 | H1-12 | H1-13 |
| Suitability | Lamination Strength | 5 | 5 | 2 | 3 | 3 | 1 | 5 | 2 | 1 | 5 | 5 | 5 | 5 |

TABLE 6-1

| | | | | | | | | | | | | | | Reference |
|---|---|---|---|---|---|---|---|---|---|---|---|---|---|---|
| | | | | Examples | | | | | | | | | | Example |
| | | | | 2-1 | 2-2 | 2-3 | 2-4 | 2-5 | 2-6 | 2-7 | 2-8 | 2-9 | 2-10 | 2-11 |
| Ink | | | | S2-1 | S2-2 | S2-3 | S2-4 | S2-5 | S2-6 | S2-7 | S2-8 | S2-9 | S2-10 | S2-11 |
| Mixing | Binder | Polyurethane | PU2-1 | 30 | 30 | 30 | 30 | 30 | 30 | 30 | 30 | 30 | | |
| Composition | Resin (B) | Resin (b1) | PU2-2 | | | | | | | | | | 30 | |
| | Solution | | PU2-3 | | | | | | | | | | | 30 |
| | | Vinyl Chloride | Vinyl Chloride- | 5 | 5 | 5 | 5 | 5 | 5 | 5 | 5 | 5 | 5 | 5 |
| | | Copolymer | Vinyl Acetate | | | | | | | | | | | |
| | | Resin (b2) | Copolymer Resin | | | | | | | | | | | |
| | | | SOLBIN TAO | | | | | | | | | | | |
| | | | Vinyl Chloride- | | | | | | | | | | | |
| | | | Acrylic Copolymer | | | | | | | | | | | |
| | | | Resin PVAc1 | | | | | | | | | | | |

| Pigment (A) | CR-57 | | | | | | | | | | | |
|---|---|---|---|---|---|---|---|---|---|---|---|---|
| (Titanium Oxide) | JR-806 | 30 | 30 | 30 | 30 | 30 | 30 | 30 | 30 | 30 | 30 | 30 |
| | CR-85 | | | | | | | | | | | |
| | JA-3 | | | | | | | | | | | |
| Organic Solvent (C) | n-Propyl Acetate/ | 29.0 | 29.0 | 29.0 | 29.0 | 29.0 | 29.0 | 31.8 | 27.0 | 24.0 | 29.0 | 29.0 |
| | IPA = 70/30 | | | | | | | | | | | |

| | | | | | | | | | | | | |
|---|---|---|---|---|---|---|---|---|---|---|---|---|
| | 1-Propanol | | | | | | | | | | | |
| Glycol Ether- | Ethylene Glycol | 3 | | | | | | | | | | |
| Based Organic | Monomethyl Ether | | | | | | | | | | | |
| Solvent (c1) | Propylene Glycol | | 3 | | | | | 0.2 | 5 | 8 | 3 | 3 |
| | Monomethyl Ether | | | | | | | | | | | |
| | Ethylene Glycol | | | 3 | | | | | | | | |
| | Monoisopropyl Ether | | | | | | | | | | | |
| | Propylene Glycol | | | | 3 | | | | | | | |
| | Mono-n-propyl Ether | | | | | | | | | | | |
| | Diethylene Glycol | | | | | 3 | | | | | | |
| | Monoisobutyl Ether | | | | | | | | | | | |
| | Triethylene Glycol | | | | | | 3 | | | | | |
| | Monomethyl Ether | | | | | | | | | | | |

| | | | | | | | | | | | |
|---|---|---|---|---|---|---|---|---|---|---|---|
| Water (D) | 3 | 3 | 3 | 3 | 3 | 3 | 3 | 3 | 3 | 3 | 3 |
| Total (%) | 100 | 100 | 100 | 100 | 100 | 100 | 100 | 100 | 100 | 100 | 100 |

| | | | | | | | | | | | | |
|---|---|---|---|---|---|---|---|---|---|---|---|---|
| Resin Composition | (b1)/((b1) + (b2))% | 85.7 | 85.7 | 85.7 | 85.7 | 857 | 85.7 | 85.7 | 85.7 | 85.7 | 85.7 | 85.7 |
| (Solid Content Ratio) | (b2)/((b1) + (b2))% | 14.3 | 14.3 | 14.3 | 14.3 | 14.3 | 14.3 | 14.3 | 14.3 | 14.3 | 14.3 | 14.3 |

TABLE 6-2

| | | | | Examples | | | | | | | | | | |
|---|---|---|---|---|---|---|---|---|---|---|---|---|---|---|
| | | | | 2-12 | 2-13 | 2-14 | 2-15 | 2-16 | 2-17 | 2-18 | 2-19 | 2-20 | 2-21 | 2-22 |
| Ink | | | | S2-12 | S2-13 | S2-14 | S2-15 | S2-16 | S2-17 | S2-18 | S2-19 | S2-20 | S2-21 | S2-22 |
| Mixing | Binder | Polyurethane | PU2-1 | 30 | 30 | 30 | 27.5 | 15 | 15 | 30 | 30 | 30 | 30 | 30 |
| Composition | Resin (B) | Resin (b1) | PU2-2 | | | | | | | | | | | |
| | Solution | | PU2-3 | | | | | | | | | | | |
| | | Vinyl Chloride | Vinyl Chloride- | 5 | 5 | 5 | 2.5 | 15 | 20 | | | 5 | 5 | 5 |
| | | Copolymer | Vinyl Acetate | | | | | | | | | | | |
| | | Resin (b2) | Copolymer Resin | | | | | | | | | | | |
| | | | SOLBIN TAO | | | | | | | | | | | |
| | | | Vinyl Chloride- | | | | | | | 5 | 5 | | | |
| | | | Acrylic Copolymer | | | | | | | | | | | |
| | | | Resin PVAc1 | | | | | | | | | | | |

| Pigment (A) | CR-57 | | | | | | | | | 30 | | |
|---|---|---|---|---|---|---|---|---|---|---|---|---|
| (Titanium Oxide) | JR-806 | 30 | 30 | 30 | 30 | 30 | 30 | 30 | 30 | | | |
| | CR-85 | | | | | | | | | | 30 | |
| | JA-3 | | | | | | | | | | | 30 |
| Organic Solvent (C) | n-Propyl Acetate/ | 31.8 | 31.0 | 27.0 | 34.0 | 34.0 | 29.0 | 27.0 | 27.0 | 29.5 | 29.5 | 29.5 |
| | IPA = 70/30 | | | | | | | | | | | |

| | | | | | | | | | | | | |
|---|---|---|---|---|---|---|---|---|---|---|---|---|
| | 1-Propanol | | | | | | | | 2.5 | | | |
| Glycol Ether- | Ethylene Glycol | | | | | | | | | | | |
| Based Organic | Monomethyl Ether | | | | | | | | | | | |
| Solvent (c1) | Propylene Glycol | 3 | 3 | 3 | 3 | 3 | 3 | 2.5 | 2.5 | 2.5 | 2.5 | 2.5 |
| | Monomethyl Ether | | | | | | | | | | | |
| | Ethylene Glycol | | | | | | | 2.5 | | | | |
| | Monoisopropyl Ether | | | | | | | | | | | |
| | Propylene Glycol | | | | | | | | | | | |
| | Mono-n-propyl Ether | | | | | | | | | | | |
| | Diethylene Glycol | | | | | | | | | | | |
| | Monoisobutyl Ether | | | | | | | | | | | |
| | Triethylene Glycol | | | | | | | | | | | |
| | Monomethyl Ether | | | | | | | | | | | |

| | | | | | | | | | | | |
|---|---|---|---|---|---|---|---|---|---|---|---|
| Water (D) | 0.2 | 1 | 5 | 3 | 3 | 3 | 3 | 3 | 3 | 3 | 3 |
| Total (%) | 100 | 100 | 100 | 100 | 100 | 100 | 100 | 100 | 100 | 100 | 100 |

| | | | | | | | | | | | | |
|---|---|---|---|---|---|---|---|---|---|---|---|---|
| Resin Composition | (b1)/((b1) + (b2))% | 85.7 | 85.7 | 85.7 | 91.7 | 50.0 | 42.9 | 85.7 | 85.7 | 85.7 | 85.7 | 85.7 |
| (Solid Content Ratio) | (b2)/((b1) + (b2))% | 14.3 | 14.3 | 14.3 | 8.3 | 50.0 | 57.1 | 14.3 | 14.3 | 14.3 | 14.3 | 14.3 |

TABLE 7

| | | | | Comparative Examples | | | | | | | | |
|---|---|---|---|---|---|---|---|---|---|---|---|---|
| | | | | 2-1 | 2-2 | 2-3 | 2-4 | 2-5 | 2-6 | 2-7 | 2-8 | 2-9 |
| Ink | | | | T2-1 | T2-2 | T2-3 | T2-4 | T2-5 | T2-6 | T2-7 | T2-8 | T2-9 |
| Mixing | Binder | Polyurethane Resin (b1) | PU2-1 | 35 | 34 | 10 | 30 | 30 | 30 | 30 | 30 | 35 |
| Composition | Resin (B) | Vinyl Chloride | Vinyl Chloride-Vinyl | | 1 | 25 | 5 | 5 | 5 | 5 | 5 | |
| | Solution | Copolymer Resin (b2) | Acetate Copolymer | | | | | | | | | |
| | | | Resin SOLBIN TAO | | | | | | | | | |

| | | | | | | | | | | |
|---|---|---|---|---|---|---|---|---|---|---|
| Pigment (A) | JR-806 | 30 | 30 | 30 | 30 | 30 | 30 | 30 | 30 | |
| (Titanium Oxide) | JA-3 | | | | | | | | | 30 |
| Organic Solvent (C) | n-Propyl Acetate/ | 27 | 27 | 27 | 30 | 32 | 35 | 7 | 20 | 27 |
| | IPA = 70/30 | | | | | | | | | |

| | | | | | | | | | | |
|---|---|---|---|---|---|---|---|---|---|---|
| Glycol Ether-Based | Ethylene Glycol | 5 | 5 | 5 | 5 | 0 | 0 | 25 | 5 | 5 |
| Organic Solvent (c1) | Monomethyl Ether | | | | | | | | | |

| | | | | | | | | | |
|---|---|---|---|---|---|---|---|---|---|
| Water (D) | 3 | 3 | 3 | 0 | 3 | 0 | 3 | 10 | 3 |
| Total (%) | 100 | 100 | 100 | 100 | 100 | 100 | 100 | 100 | 100 |

| | | | | | | | | | | |
|---|---|---|---|---|---|---|---|---|---|---|
| Resin Composition | (b1)/((b1) + (b2))% | 100.0 | 97.1 | 28.6 | 85.7 | 85.7 | 85.7 | 85.7 | 85.7 | 100.0 |
| (Solid Content Ratio) | (b2)/((b1) + (b2))% | 0.0 | 2.9 | 71.4 | 14.3 | 14.3 | 14.3 | 14.3 | 14.3 | 0.0 |

TABLE 8-1

| | | | | | | | | | | | | Reference |
|---|---|---|---|---|---|---|---|---|---|---|---|---|
| | | Examples | | | | | | | | | | Example |
| | | 2-23 | 2-24 | 2-25 | 2-26 | 2-27 | 2-28 | 2-29 | 2-30 | 2-31 | 2-32 | 2-33 |
| Printing | Ink Name | S2-1 | S2-2 | S2-3 | S2-4 | S2-5 | S2-6 | S2-7 | S2-8 | S2-9 | S2-10 | S2-11 |
| Performance | Ink Stability 2 | 5 | 5 | 5 | 5 | 4 | 4 | 5 | 5 | 5 | 5 | 4 |
| | (40° C., 14 days) | | | | | | | | | | | |
| | Whitening | 5 | 5 | 5 | 5 | 5 | 5 | 5 | 5 | 5 | 5 | 4 |
| | Filming Property | 5 | 5 | 5 | 5 | 4 | 5 | 4 | 5 | 5 | 5 | 5 |
| | Doctor Blade Wear Property | 5 | 5 | 5 | 5 | 5 | 5 | 5 | 5 | 5 | 5 | 4 |
| | Fogging Property | 5 | 5 | 5 | 5 | 4 | 4 | 5 | 5 | 4 | 5 | 5 |
| Lamination | Printed Material | G2-1 | G2-2 | G2-3 | G2-4 | G2-5 | G2-6 | G2-7 | G2-8 | G2-9 | G2-10 | G2-11 |
| Suitability | Lamination Strength | 5 | 5 | 5 | 5 | 5 | 5 | 5 | 5 | 5 | 5 | 5 |

| | | Examples | | | | | | | | | | |
|---|---|---|---|---|---|---|---|---|---|---|---|---|
| | | 2-34 | 2-35 | 2-36 | 2-37 | 2-38 | 2-39 | 2-40 | 2-41 | 2-42 | 2-43 | 2-44 |
| Printing | Ink Name | S2-12 | S2-13 | S2-14 | S2-15 | S2-16 | S2-17 | S2-18 | S2-19 | S2-20 | S2-21 | S2-22 |
| Performance | Ink Stability 2 | 4 | 5 | 5 | 5 | 5 | 5 | 5 | 5 | 5 | 5 | 4 |
| | (40° C., 14 days) | | | | | | | | | | | |
| | Whitening | 5 | 5 | 5 | 5 | 5 | 5 | 5 | 5 | 5 | 5 | 5 |
| | Filming Property | 5 | 5 | 5 | 5 | 5 | 5 | 5 | 5 | 5 | 5 | 5 |
| | Doctor Blade Wear Property | 5 | 5 | 5 | 4 | 5 | 5 | 6 | 5 | 5 | 5 | 4 |
| | Fogging Property | 5 | 5 | 4 | 5 | 5 | 5 | 5 | 5 | 5 | 5 | 4 |
| Lamination | Printed Material | G2-12 | G2-13 | G2-14 | G2-15 | G2-16 | G2-17 | G2-18 | G2-19 | G2-20 | G2-21 | G2-22 |
| Suitability | Lamination Strength | 5 | 5 | 5 | 5 | 5 | 4 | 5 | 5 | 4 | 5 | 4 |

TABLE 8-2

| | | Comparative Examples | | | | | | | | |
|---|---|---|---|---|---|---|---|---|---|---|
| | | 2-10 | 2-11 | 2-12 | 2-13 | 2-14 | 2-15 | 2-16 | 2-17 | 2-18 |
| Printing | Ink Name | T2-1 | T2-2 | T2-3 | T2-4 | T2-5 | T2-6 | T2-7 | T2-8 | T2-9 |
| Performance | Ink Stability 2 | 3 | 3 | 5 | 2 | 4 | 2 | 3 | 2 | 3 |
| | (40° C., 14 days) | | | | | | | | | |
| | Whitening | 4 | 4 | 5 | 3 | 3 | 3 | 5 | 2 | 4 |
| | Filming Property | 3 | 3 | 4 | 4 | 2 | 2 | 5 | 2 | 3 |
| | Doctor Blade Wear Property | 3 | 3 | 4 | 3 | 3 | 2 | 4 | 3 | 2 |
| | Fogging Property | 3 | 4 | 3 | 2 | 3 | 2 | 1 | 3 | 2 |
| Lamination | Printed Material | H2-1 | H2-2 | H2-3 | H2-4 | H2-5 | H2-6 | H2-7 | H2-8 | H2-9 |
| Suitability | Lamination Strength | 4 | 4 | 1 | 3 | 3 | 2 | 4 | 2 | 3 |

The evaluation results shown in Tables revealed that the solvent-type gravure ink for a laminate according to the present invention experienced no whitening of a printed layer, produced less filming and doctor wear associated with ink deposits, and excelled in printability in gravure printing under a high-temperature, high-humidity condition.

This application claims priority to Japanese Patent Application No. 2016-147360, filed on Jul. 27, 2016 and Japanese Patent Application No. 2017-021944, filed on Feb. 9, 2017, and the entire disclosures of which are incorporated herein.

1-10. (canceled)

11. A solvent-type gravure ink for a laminate, comprising:
a pigment;
a binder resin;
an organic solvent; and
water,
wherein
the solvent-type gravure ink contains 80 to 100 mass % in total of a polyurethane resin and a vinyl chloride copolymer resin in 100 mass % of the binder resin, and a mass ratio of the polyurethane resin and the vinyl chloride copolymer resin is 95:5 to 40:60,
the solvent-type gravure ink contains 1 to 50 mass % of a structural unit derived from a polyether in 100 mass % of the polyurethane resin, and
the solvent-type gravure ink contains 0.1 to 15 mass % of a glycol ether-based organic solvent serving as the organic solvent and 0.1 to 5 mass % of the water in 100 mass % of the gravure ink.

12. The solvent-type gravure ink for a laminate according to claim 11, wherein the glycol ether-based organic solvent has a solubility parameter of 9.0 to 12.0.

13. The solvent-type gravure ink for a laminate according to claim 11, wherein the glycol ether-based organic solvent has a boiling point of 110° C. to 240° C.

14. The solvent-type gravure ink for a laminate according to claim 11, wherein the pigment includes an organic pigment.

15. The solvent-type gravure ink for a laminate according to claim 14, wherein the pigment includes at least one organic pigment selected from the group consisting of a phthalocyanine pigment and an azo lake pigment.

16. The solvent-type gravure ink for a laminate according to claim 11, wherein the pigment includes a titanium oxide pigment.

17. The solvent-type gravure ink for a laminate according to claim 16, wherein the titanium oxide pigment is at least a rutile-type titanium oxide surface-treated with at least one metal oxide selected from the group consisting of silica and alumina.

18. The solvent-type gravure ink for a laminate according to claim 11, wherein the glycol ether-based organic solvent is at least one selected from the group consisting of ethylene glycol monoalkyl ether and propylene glycol monoalkyl ether.

19. A printed material having a printed layer on a substrate, the printed layer being printed with the solvent-type gravure ink for a laminate according to claim 11.

20. A layered product having at least an adhesive layer and a film layer in this order provided on the printed layer of the printed material according to claim 19.
